(19) United States
(12) Patent Application Publication
(10) Pub. No.: US 2019/0352223 A1
(43) Pub. Date: Nov. 21, 2019

(54) BROADBAND ANTI-REFLECTIVE SOL-GEL COATING COMPOSITION

(71) Applicant: FUNDACION TECNALIA RESEARCH & INNOVATION, DONOSTIA-SAN SEBASTIÁN (ES)

(72) Inventors: Cecilia AGUSTIN SAENZ, DONOSTIA - SAN SEBASTIÁN (ES); Oihana ZUBILLAGA ALCORTA, DONOSTIA - SAN SEBASTIÁN (ES); Marta BRIZUELA PARRA, DONOSTIA - SAN SEBASTIÁN (ES)

(21) Appl. No.: 16/477,096

(22) PCT Filed: Jan. 16, 2018
(86) PCT No.: PCT/EP2018/050924

§ 371 Date: Jul. 10, 2019

(30) Foreign Application Priority Data
Jan. 16, 2017 (EP) 17382016.8

(51) Int. Cl. C03C 17/25; C03C 17/34; C23C 18/12; C09D 5/00; C09D 1/00

(52) U.S. Cl. CPC C03C 17/25; C03C 17/3417; C23C 18/1212; C23C 18/1225; C23C 18/1245; C03C 2217/73; C09D 5/006; C09D 1/00; C03C 2217/732; C03C 2218/113; C23C 18/1254

(57) ABSTRACT

The present invention relates to a process for preparing an anti-reflective sol-gel coating composition comprising: a) mixing a hydrolysable silicon alkoxide, (C₁-C₈)alcohols, an aqueous solution of one acid catalyst; and one or more surfactants of formula (II) wherein: R⁹ is (C₁-C₃₀)alkyl, and m is an integer selected from 2 to 40; the concentration of the surfactant of formula (II) is from 150 to 300 g/L; the molar ratio hydrolysable silicon alkoxide and aqueous solution of acid catalyst is from 0.15 to 1; the molar ratio hydrolysable silicon alkoxide and (C₁-C₈)alcohol is from 0.15 to 0.30, and molar ratio hydrolysable silicon alkoxide and the surfactant of formula (II) is from 7 to 11.5; b) preparing a second mixture by mixing (C₁-C₈)alcohols, and an aqueous solution of one acid catalyst; c) adding the second mixture to the mixture of step a); and adding (C₁-C₈)alcohols until the molar ratio hydrolysable silicon alkoxide and (C₁-C₈)alcohol is from 0.025 to 0.100 and the composition thus obtained. It also relates to a process for coating a substrate; and the anti-reflective coating on a substrate or the anti-reflective stack on a substrate thus obtained. HO(CH₂CH₂0)mR⁹ (II)

This application claims the benefit of the European Patent Application EP17382016.8 filed on Jan. 16, 2017.

The present invention relates to sol-gel coatings, particularly to silica-based sol-gel coating compositions useful for the preparation of single anti-reflective coatings on a substrate or broadband anti-reflective multi-layer stacks showing graded refractive index profile on a substrate. The present invention also relates to a process for the preparation of the anti-reflective sol-gel coating composition and to a process for the preparation of single anti-reflective coatings on a substrate or anti-reflective multi-layer stacks on a substrate.

### BACKGROUND ART

Glass is extensively used in optical and optoelectronic applications such as lenses, screens, substrates for photodetectors, sensors and solar cells assemblies, due to its high optical transmission in a wide range of the solar spectrum, so as to its relatively low cost, thermal and mechanical stability. These features are the reason behind it is used on assembly systems whose application imply exposure to harsh environmental conditions (such as heat, ultraviolet radiation and corrosive media), and need protection and insulation such as photovoltaic modules.

However, although it exhibits high transparency, because of the difference between the refractive index of glass and medium, generally air, Fresnel reflection losses are produced in the interface, being up to 8% in solar spectrum range. Optical reflection is a phenomenon occurring when light propagates across a boundary between two media which have different refractive indexes. Broadband anti-reflection effect can be obtained by means of interference-type multi-layer stacks. This anti-reflection structure utilizes the light-matter interaction principles of thin film optics to produce destructive interference of the light reflected at the upper and the lower interfaces of the thin film/substrate system.

In order to achieve anti-reflection effect, total reflection of the anti-reflective system can be minimised by adjusting the refractive index and thickness of each layer thus producing the mentioned destructive interference of the light reflected on each interphase. Depending on the needs of optical performance, anti-reflective coating system may contain single or multiple layers; a single layer covers a narrow bandwidth while broadband optical performance can be achieved by multi-layer stack.

The required value of refractive index for the layers of this system (glass/air) is so low that no bulk materials can meet this criterion, thus some alternative must be implemented, like introducing voids into the material. Several techniques, as chemical etching, magnetron sputtering and “sol-gel” can be used for that purpose. “Sol-gel” process is a versatile method which permits precise control on the film microstructure, such as pore volume, pore size and surface area, besides being low cost method.

“Sol-gel” processes for the preparation of homogeneous high porosity coatings having a narrow pore size distribution have been disclosed in the state of the art. Particularly, those porous coatings have been prepared by sol-gel processes performed by the surfactant templating technique. This technique involves the synthesis of structured mesoporous solids based on the supramolecular templating approach, where long chain organic surfactants are used as structure-directing agents (SDA) or templates. The assembly of these surfactant molecules in the presence of a hard precursor leads to a composite mesostructure during the condensation of the silica network. The subsequent removal of the surfactant gives a mesoporous material with a porous systems replicating the surfactant's assembly.

Additionally, other properties like anti-soiling and durability properties are also a key issue to consider for outdoor applications, as the exposed surface should be capable of withstanding prolonged exposure in open air climates (including desert and tropical ones). When the surface is soiled, a significant part of the light can be scattered and thus, lost. In this sense, hydrophobic or water-repellent coatings can be used to prevent contamination and avoid water and fog condensation onto surface. Durability effects of the anti-reflective surface have to be considered when long-term high performance stability with no optical transmittance loss is needed. Thus, surface treatments combining durable anti-reflective and anti-soiling properties are of interest to fulfil multi-functional necessities related to outstanding optical performance exhibition in outdoor applications thus improving the efficiency of the system.

Therefore, from what is known in the art it is derived that there is still the need of providing a durable, anti-soiling, anti-reflective coatings or stacks with superior broadband optical properties.

### SUMMARY OF THE INVENTION

Inventors have provided an anti-reflective (AR) sol-gel coating composition comprising a specific mixture of components and which allows the preparation of a single anti-reflective coating or anti-reflective multi-layer stack on a substrate having enhanced anti-reflective properties over a broad wavelength range (broadband). The single anti-reflective sol-gel coating on a substrate or anti-reflective multi-layer stack on a substrate is obtainable by the deposition of the specific sol-gel coating compositions of the invention and the subsequent sintering of the coating or stack thus obtained. Inventors have also provided single anti-reflective and water-repellent coating on a substrate obtained in a single step having enhanced optical properties and also allows the preparation of anti-reflective and water-repellent multi-layer stacks.

Furthermore, inventors have found that by using the anti-reflective sol-gel coating composition of the invention, single anti-reflective coatings or anti-reflective multi-layer stacks having a good performance regarding durability of the anti-reflection properties is obtained.

Thus, a first aspect of the present invention relates to a process for preparing an anti-reflective sol-gel coating composition comprising: a) first mixing a hydrolysable silicon alkoxide, one or more (C₁-C₈)alcohols, an aqueous solution of at least one acid catalyst; and one or more surfactants of formula (II):

HO(CH₂CH₂O)ₘR⁹ (II)

then maintaining the resulting mixture at a temperature comprised from 50° C. to 120° C. for an appropriate period of time; and finally cooling the mixture until reaching a temperature comprised from 30° C. to 50° C., wherein: R⁹ is (C₁-C₃₀)alkyl, and m is an integer selected from 2 to 40; the concentration of the surfactant of formula (II) in the resulting first mixture is comprised from 150 g/L to 300 g/L; the molar ratio between the hydrolysable silicon alkoxide and the aqueous solution of acid catalyst is comprised from 0.15 to 1; and the molar ratio between the hydrolysable silicon alkoxide and the (C₁-C₈)alcohol is comprised from 0.15 to 0.30, and the molar ratio between the hydrolysable silicon alkoxide and the surfactant of formula (II) is comprised from 7 to 11.5; b) preparing a second mixture by mixing one or more (C₁-C₈)alcohols, and an aqueous solution of at least one acid catalyst; and maintaining the resulting mixture at a temperature comprised from 15° C. to 30° C.; c) adding the second mixture obtained in step b) to the resulting mixture of step a); and maintaining the resulting mixture at a temperature comprised from 30° C. to 50° C. for an appropriate period of time; and d) cooling the resulting mixture obtained in step c) until reaching a temperature comprised from 15° C. to 30° C.; and adding one or more (C₁-C₈)alcohols until the molar ratio between the hydrolysable silicon alkoxide and the (C₁-C₈)alcohol in the anti-reflective sol-gel coating composition is comprised from 0.025 to 0.100, wherein: the concentration of the surfactant of formula (II) in the anti-reflective sol-gel coating composition is comprised from 55 g/L to 90 g/L, the molar ratio between the hydrolysable silicon alkoxide and the aqueous solution of at least one acid catalyst is comprised from 0.050 to 0.350, and the molar ratio between the hydrolysable silicon alkoxide and the surfactant of formula (II) is comprised from 7 to 11.5.

A second aspect of the present invention relates to the process as defined in the first aspect of the invention, wherein the process further comprises adding a silicon precursor having at least one non-hydrolysable substituent bonded to the silicon atom to the initial mixture of step a).

The third aspect of the invention relates to an anti-reflective sol-gel coating composition obtainable by the process as defined in the first aspect of the invention.

The fourth aspect of the invention relates to an anti-reflective water-repellent sol-gel coating composition obtainable by the process as defined in the second aspect of the invention.

The fifth aspect of the invention relates to a process for preparing a single anti-reflective coating on a substrate which comprises: e) depositing a mono-layer of the anti-reflective sol-gel coating composition as defined in the third aspect of the invention or alternatively, the anti-reflective water-repellent sol-gel coating composition as defined in the fourth aspect of the invention over the substrate; and f) sintering the coating obtained in step e).

The sixth aspect of the invention relates to a process for preparing an anti-reflective multi-layer stack on a substrate which comprises: g) firstly, depositing a first inner layer over the substrate by a process which comprises: g1) providing a sol-gel coating composition obtainable by a process which comprises: g1a) first mixing an hydrolysable silicon alkoxide, one or more C₁-C₈ alcohols, and an aqueous solution of at least one acid catalyst; and then maintaining the resulting mixture at a temperature comprised from 50° C. to 70° C. for an appropriate period of time; and finally cooling the mixture until reaching a temperature comprised from 30° C. to 50° C.; g1b) preparing a second mixture by mixing one or more C₁-C₈ alcohols, and an aqueous solution of at least one acid catalyst; and maintaining the resulting mixture at a temperature comprised from 15° C. to 30° C. for an appropriate period of time; g1c) adding the second mixture obtained in step g1b) to the resulting mixture of step g1a); and maintaining the resulting mixture at a temperature comprised from 30° C. to 50° C. for an appropriate period of time; g2) depositing the sol-gel coating composition over the substrate; and g3) drying or sintering the coating obtained in step g2); and h) secondly, depositing an external anti-reflective layer over the inner layer on the substrate, by a process which comprises: h1) depositing the anti-reflective sol-gel coating composition as defined in the third aspect of the invention or alternatively, the anti-reflective water-repellent sol-gel coating composition as defined in the fourth aspect of the invention, over the inner layer on the substrate; and h2) sintering the coating obtained in step h1).

The seventh aspect of the invention relates to a single anti-reflective coating on a substrate or an anti-reflective multi-layer stack on a substrate obtainable by the process as defined in the fifth and the sixth aspect of the invention.

### BRIEF DESCRIPTION OF DRAWINGS

FIG. 1 shows the ultraviolet-visible-near infrared spectrophotometry of the single anti-reflective coating of Example M5 of the present invention onto low iron soda lime silica float glass (dashed line), the anti-reflective multi-layer (bi-layer) stack of Example B5 of the present invention onto low iron soda lime silica float glass (solid line), and bare substrate (BS) that is bare low iron soda lime silica float glass (pointed line). The spectrum expresses transmittance (T) in % versus wavelength (W) expressed in nm.

FIG. 2 shows the ultraviolet-visible-near infrared spectrophotometry of the single anti-reflective and water-repellent coating of Example M6 of the present invention onto low iron soda lime silica float glass (dashed line), the anti-reflective and water-repellent multi-layer (bi-layer) stack of Example B6 of the present invention onto low iron soda lime silica float glass (solid line), and bare substrate (BS) that is bare low iron soda lime silica float glass (pointed line). The spectrum expresses transmittance T in % versus wavelength (W) expressed in nm.

### DETAILED DESCRIPTION OF THE INVENTION

All terms as used herein in this application, unless otherwise stated, shall be understood in their ordinary meaning as known in the state of the art. Other more specific definitions for certain terms as used in the present application are as set forth below and are intended to apply uniformly throughout the specification and claims unless an otherwise expressly set out definition provides a broader definition.

For purposes of the present invention, any ranges given include both the lower and the upper end-points of the range. Ranges given, such as temperatures, times, and the like, should be considered approximate, unless specifically stated.

The term “sol-gel” or “solution sol-gel” or “SSG” process have the same meaning and are used interchangeable. They refers to a chemical process that are used for the synthesis of single- or multiple-component materials, including glasses, in the form of thin solid films, ultrafine powders, high surface area porous materials, dense abrasive minerals, and continuous ceramic and glass fibres. In particular, a single “sol-gel” coating or a “sol-gel” multi-layer stack is prepared by a “sol-gel” process that involves the preparation of one or more precursor mixtures (also called “sol”), which are converted into intermediate product (also called “gel”) and thereof into a specified material by a process that may involve chemical reactions, product forming, gelification, drying and sintering.

The term “sol” refers to either a dispersion of colloidal particles of one phase in a fluid medium or a solution prepared by hydrolysis and polycondensation of metalorganic derivatives compounds or inorganic salts in alcoholic solution. The term “gel” refers to a material consisting of a three-dimensional network of a solid phase interwoven with an entrapped and immobilized continuous liquid phase.

The term “sol-gel coating” refers to a coating obtainable by each of the “sol-gel” compositions that are defined along the document.

The term “anti-reflective” refers to a physical property provided by the sol-gel coating composition that permits to obtain surface with anti-reflection or high-transmission properties in comparison to bare substrate after depositing on a substrate; or to a physical property provided by single coating on a substrate or a multilayer stack on a substrate that provide anti-reflection or high-transmission properties in comparison to bare substrate.

The term “anti-reflective system” and “anti-reflective coating system” refers to a single coating or a coating sequence (stack) on a substrate that is composed by one or more layers obtainable by depositing the “sol-gel” coating composition of the present invention. Thus, the term “anti-reflective system” encompasses the term “anti-reflective coating” and the term “anti-reflective coating stack”.

The terms “anti-reflective coating”, “single anti-reflective coating” and “anti-reflective mono-layer” or “anti-reflective (mono-layer) coating” have the same meaning and are used interchangeable. They refer to a coating on a substrate that is composed by one layer obtainable by depositing the “sol-gel” coating composition of the present invention.

The terms “anti-reflective coating stack” and “anti-reflective multi-layer stack” have the same meaning and are used interchangeable. They refer to a coating sequence on a substrate that is composed by at least two coating or layers obtainable by depositing of “sol-gel” coating compositions, wherein at least one of the layers is formed by the deposition of a “sol-gel” coating composition of the present invention.

The term “anti-reflective bi-layer stack” refers to a specific case of “anti-reflective multi-layer stack”. It refers to a coating sequence on a substrate that is composed by two coating or layers obtainable by depositing of “sol-gel” coating compositions, wherein at least one of the layers is formed by the deposition of a “sol-gel” coating composition of the present invention.

The term “broadband” refers to a wavelength range integrated in electromagnetic spectrum, particularly covering the most powerful part of sunlight wavelength range; more precisely the wavelength is comprised from 300 nm to 2000 nm.

The term “alkyl” refers to a saturated straight, or branched hydrocarbon chain which contains the number of carbon atoms specified in the description or claims. Examples include, among others, the group methyl, ethyl, propyl, isopropyl, butyl, isobutyl, sec-butyl, tert-butyl, n-pentyl, and n-hexyl.

The term “(C₂-C₁₄)alkenyl” refers to a saturated straight or branched alkyl chain which contains from 2 to 14 carbon atoms and that also contains one or more double bonds. Examples include, among others, ethenyl, 1-propen-1-yl, 1-propen-2-yl, 3-propen-1-yl, 1-buten-1-yl, 1-buten-2-yl, 3-buten-1-yl, 3-buten-2-yl, 2-buten-1-yl, 2-buten-2-yl, 2-methyl-1-propen-1-yl, 2-methyl-2-propen-1-yl, 1,3-butadien-1-yl, 1,3-butadien-2-yl, and 2-hexenyl.

The term “(C₂-C₁₄)alkynyl” refers a saturated straight or branched alkyl chain which contains from 2 to 14 carbon atoms and that also contains one or more triple bonds. Examples include, among others, ethynyl, 1-propynyl, 2-butynyl, 1,3-butadinyl, 4-pentynyl, and 1-hexynyl.

The term “(C₅-C₆)aryl” refers to a 5 to 6 membered ring, saturated, partially or totally unsaturated, optionally bridged or fused to a 5 to 6 membered ring; the members of the rings being independently selected from C, CH, CH₂, O, N, NH, and S; being one or more of the hydrogen atoms of the members optionally substituted by a radical selected from the group consisting of (C₁-C₆)alkyl, (C₁-C₆)haloalkyl, halogen, (C₁-C₆)alkoxy, (C₁-C₆)alkylcarbonyl, (C₁-C₆)alkyloxycarbonyl, nitro and cyano.

The term “fluoro-(C₁-C₁₄)alkyl” refers to a saturated straight, or branched hydrocarbon wherein at least one hydrogen atom is substituted by a fluorine atom and which contains from 1 to 14 carbon atoms. Examples include, among others, the group trifluoromethyl/perfluoromethyl, perfluoroethyl, perfluoropropyl, perfluoroisopropyl, perfluorosbutyl, perfluoroisobutyl, perfluoro-sec-butyl, perfluoro-tert-butyl, perfluoro-n-pentyl, peril uoro-hexyl, peril uoro-octyl, peril uoro-dodecyl peril uoro-decyl.

The term “fluoro-(C₂-C₁₄)alkenyl” refers to a saturated straight, or branched alkyl chain which contains from 2 to 14 carbon atoms and that also contains one or more double bonds, wherein at least one hydrogen atom is substituted by a fluorine atom. Examples include, among others, perfluorovinyl (CF₂═CF), monofluorovinyl, 2,2-difluorovinyl (CF₂═CH), perfluoroallyl (CF₃CF₂═CF), perfluoro-1-butenyl, perfluoro-2-butenyl, 1,1-ditrifluoromethyl-2-fluorovinyl ((CF₃)₂C═CF₂), perfluoropentenyl and perfluorohexenyl.

The term “fluoro-(C₂-C₁₄)alkynyl” refers a saturated straight, or branched alkyl chain which contains from 2 to 14 carbon atoms and that also contains one or more triple bonds, wherein at least one hydrogen atom is substituted by a fluorine atom.

The term “fluoro-(C₅-C₆)aryl” refers to a 5 to 6 membered ring, saturated, partially or totally unsaturated, optionally bridged or fused to a 5 to 6 membered ring, wherein at least one hydrogen atom is substituted by a fluorine atom; the members of the rings being independently selected from C, CH, CH₂, O, N, NH, and S; being one or more of the hydrogen atoms of the members optionally substituted by a radical selected from the group consisting of (C₁-C₆)alkyl, (C₁-C₆)haloalkyl, halogen, (C₁-C₆)alkoxy, (C₁-C₆)alkylcarbonyl, (C₁-C₆)alkyloxycarbonyl, nitro and cyano.

The term “halogen” refers to fluorine, chlorine, bromine and iodine.

The term “molar ratio” refers to the relation of mols between the different components of the anti-reflective coating compositions, the single anti-reflective coating on a substrate or the anti-reflective multi-layer stack of the present invention. For example, the relation of mols between the components intervening in the preparation of the first mixture (step a); or the relation of mols between the hydrolysable silicon alkoxide and the aqueous solution of the acid catalyst.

The term “glass” refers to a non-crystalline amorphous solid that is often transparent. The term “glass” is often defined in a broader sense, encompassing every solid that possesses a non-crystalline structure at the atomic scale and that exhibits a glass transition when heated towards the liquid state. In any case, the term “glass” encompasses the terms “silica glass” and “oxide glass”. In particular, the term “silica glass” refers to any silica-based glass and combination thereof known in the state of the art. And, the term “oxide glass” refers to a glass that comprises oxide selected from the group consisting of Aluminum oxide, Antimony trioxide, Arsenic trioxide, Barium oxide, Bismuth(III) oxide, Boron trioxide, Calcium oxide, Cerium(III) oxide, Chromium(III) oxide, Gadolinium oxide, Germanium oxide, Iron(III) oxide, Lanthanum oxide, Lead(II) oxide, Lithium oxide, Magnesium oxide, Niobium pentoxide, Phosphorus pentoxide, Potassium oxide, Silicon dioxide, Sodium oxide, Strontium oxide, Sulphur dioxide, Tin dioxide, Titanium dioxide, Zinc oxide, Zirconium dioxide and combination therefore.

For the purposes of the invention the expressions “obtainable”, “obtained” and equivalent expressions are used interchangeably, and in any case, the expression “obtainable” encompasses the expression “obtained”.

As mentioned above, an aspect of the present invention refers to a process for preparing a single anti-reflective sol-gel coating composition useful for the preparation of anti-reflective coating on a substrate or anti-reflective multi-layer stacks on a substrate having durable anti-reflective properties over a broad wavelength band obtainable by a process which comprises preparing a first mixture (step a). As it is disclosed above, step a) comprises first mixing a hydrolysable silicon alkoxide, one or more C₁-C₈ alcohols, an aqueous solution of at least one acid catalyst; and one or more surfactants of formula (II)

HO(CH₂CH₂O)ₘR⁹ (II)

then maintaining the resulting mixture at a temperature comprised from 50° C. to 120° C. for an appropriate period of time; and finally cooling the mixture until reaching a temperature comprised from 30° C. to 50° C. wherein: R⁹ is (C₁-C₃₀)alkyl, and m is an integer selected from 2 to 40; the concentration of the surfactant of formula (II) in the resulting first mixture is comprised from 150 g/L to 300 g/L; the molar ratio between the hydrolysable silicon alkoxide and the aqueous solution of acid catalyst is comprised from 0.15 to 1; and the molar ratio between the hydrolysable silicon alkoxide and the (C₁-C₈)alcohol is comprised from 0.15 to 0.30, and the molar ratio between the hydrolysable silicon alkoxide and the surfactant of formula (II) is comprised from 7 to 11.5.

In an embodiment, optionally in combination with one or more features of the various embodiments described above or below, the hydrolysable silicon alkoxide is selected from the group consisting of:

i) a totally hydrolysable silicon alkoxide of formula (IA)

Si(OR¹)(OR²)(OR³)(OR⁴) (IA)

ii) an alkylalkoxide having at least one non-hydrolysable substituent being the non-hydrolysable substituent a substituted or un-substituted (C₁-C₄)alkyl of formula (IB)

R⁸—Si(OR⁵)(OR⁶)(OR⁷) (IB)

and iii) a mixture of at least a totally hydrolysable silicon alkoxide of formula (IA) and at least an alkylalkoxide having at least one non-hydrolysable substituent being the non-hydrolysable substituent a substituted or un-substituted (C₁-C₄)alkyl of formula (IB); wherein: each one of R¹, R², R³, R⁴, R⁵, R⁶ and R⁷ are independently selected from the group consisting of a substituted or un-substituted (C₁-C₁₄)alkyl, (C₅-C₆)aryl, (C₂-C₁₄)alkenyl and (C₂-C₁₄)alkynyl group; and R⁸ is a substituted or un-substituted (C₁-C₄)alkyl.

In an embodiment, optionally in combination with one or more features of the various embodiments described above or below, the hydrolysable silicon alkoxide is a totally hydrolysable silicon alkoxide of formula (IA);

Si(OR¹)(OR²)(OR³)(OR⁴) (IA)

wherein R¹, R², R³ and R⁴ are as defined in the present invention. In an embodiment, optionally in combination with one or more features of the various embodiments described above or below, the hydrolysable silicon alkoxide is a totally hydrolysable silicon alkoxide of formula (IA) selected from the group consisting of tetraethylorthosilicate (TEOS), tetramethylorthosilicate (TMOS), and mixtures thereof; preferably tetraethylorthosilicate (TEOS).

In an embodiment, optionally in combination with one or more features of the various embodiments described above or below, the hydrolysable silicon alkoxide is an alkylalkoxide having at least one non-hydrolysable substituent being the non-hydrolysable substituent a substituted or un-substituted (C₁-C₄)alkyl of formula (IB);

R⁸—Si(OR⁵)(OR⁶)(OR⁷) (IB)

wherein R⁵, R⁶, R⁷ and R⁸ are as defined in the present invention. In an embodiment, optionally in combination with one or more features of the various embodiments described above or below, the hydrolysable silicon alkoxide is an alkylalkoxide having at least one non-hydrolysable substituent being the non-hydrolysable substituent a substituted or un-substituted (C₁-C₄)alkyl of formula (IB) selected from the group consisting of methyl triethoxysilane (MTES), methyl trimethoxysilane (MTMS), and mixture thereof; preferably methyl triethoxysilane (MTES).

In an embodiment, optionally in combination with one or more features of the various embodiments described above or below, the hydrolysable silicon alkoxide is a mixture of at least a totally hydrolysable silicon alkoxide of formula (IA) and at least an alkylalkoxide having at least one non-hydrolysable substituent being the non-hydrolysable substituent a substituted or un-substituted (C₁-C₄)alkyl of formula (IB) as defined in the present invention. In an embodiment, optionally in combination with one or more features of the various embodiments described above or below, the hydrolysable silicon alkoxide is a mixture of a totally hydrolysable silicon alkoxide of formula (IA) selected from the group consisting of tetraethylorthosilicate (TEOS), tetramethylorthosilicate (TMOS) and mixtures thereof; and an alkylalkoxide having at least one non-hydrolysable substituent being the non-hydrolysable substituent a substituted or un-substituted (C₁-C₄)alkyl of formula (IB) selected from the group consisting of methyl triethoxysilane (MTES), methyl trimethoxysilane (MTMS) and mixtures thereof; preferably a mixture of tetraethylorthosilicate (TEOS) and methyl triethoxysilane (MTES).

In an embodiment, optionally in combination with one or more features of the various embodiments described above or below, the C₁-C₈ alcohols used in step a) is selected from the group consisting of ethanol, butanol, propanol, and mixtures thereof. The term “alcohol” refers to an “alkane” wherein at least one hydrogen atom is substituted by a hydroxyl group and which contains the number of carbon atoms specified in the description or claims. The term “alkane” refers to a saturated, branched or linear hydrocarbon which contains the number of carbon atoms specified in the description or claims. Examples include methanol, ethanol, n-propanol, iso-propanol, butanol, iso-butanol, and sec-butanol. In an embodiment, optionally in combination with one or more features of the various embodiments described above or below, the C₁-C₈ alcohol is ethanol. In an embodiment, optionally in combination with one or more features of the various embodiments described above or below, the molar ratio between the hydrolysable silicon alkoxide and the C₁-C₈ alcohol, preferably ethanol, in the anti-reflective sol-gel coating composition is comprised from 0.15 to 0.30; preferably comprised from 0.15 to 0.20.

In an embodiment, optionally in combination with one or more features of the various embodiments described above or below, the acid catalyst is an inorganic acid independently selected from the group consisting of H₂SO₄, HCl, HNO₃, and mixtures thereof; preferably the acid catalyst is HCl. The acid catalyst is in form of an aqueous solution having a pH lower than 5; preferably having a pH comprised from 0 to 3. In an embodiment, the acid catalyst is HCl and is in form of an aqueous solution of HCl 0.1M having a pH lower than 5; preferably having a pH comprised from 0 to 3. In an embodiment, optionally in combination with one or more features of the various embodiments described above or below, the molar ratio between the hydrolysable silicon alkoxide and the aqueous solution of the acid catalyst is comprised from 0.15 to 1; preferably is comprised from 0.35 to 0.75. In a particular embodiment, optionally in combination with one or more features of the various embodiments described above or below, the molar ratio between the hydrolysable silicon alkoxide and the aqueous solution of HCl 0.1M is comprised from 0.15 to 1; preferably comprised from 0.35 to 0.75.

The mixture of step a) also comprises one or more surfactants of formula (II):

HO(CH₂CH₂O)mR⁹ (II)

wherein R⁹ is (C₁-C₃₀)alkyl, and m is an integer selected from 2 to 40. In an embodiment, the compound of formula (II) is one wherein R⁹ is (C₁-C₂₅)alkyl and m is an integer selected from 10 to 30; preferably R⁹ is (C₁-C₂₅)alkyl and m is an integer selected from 10 to 20.

In an embodiment, optionally in combination with one or more features of the various embodiments described above or below, the surfactant of formula (II) is selected from the group consisting of polyethylene (20) oxide hexadecyl ether (Brij58), polyethylene (20) oxide octadecyl ether (Brij78), polyethylene (10) oxide hexadecyl ether (Brij56), polyethylene (30) oxide dodecyl ether (Brij35), polyethylene (4) oxide dodecyl ether (Brij30), polyethylene (2) oxide octadecyl ether (Brij93) and mixture thereof; preferably the surfactant of formula (II) is polyethylene (20) oxide hexadecyl ether (Brij 58). Particularly, the terms “Brij 58”, “polyethylene (20) oxide hexadecyl ether” and “PEO₂₀C₁₆” have the same meaning and are used interchangeable. Brij58 refers to a registered trademark of an Atlas Chemicals of Wilmington Del.'s compound of formula HO(CH₂CH₂O)₂₀C₁₆H₃₃ and having the CAS number 9004-95-9.

In an embodiment, optionally in combination with one or more features of the various embodiments described above or below, the concentration in the resulting first mixture of the surfactant of formula (II) of the invention, preferably polyethylene (20) oxide hexadecyl ether, is comprised from 150 g/L to 300 g/L; preferably comprised from 155 g/L to 280 g/L; more preferably comprised from 205 g/L to 240 g/L.

In an embodiment, optionally in combination with one or more features of the various embodiments described above or below, in step a) the molar ratio between the hydrolysable silicon alkoxide and the aqueous solution of at least one acid catalyst is comprised from 0.15 to 1; the molar ratio between the hydrolysable silicon alkoxide and the C₁-C₈ alcohol is comprised from 0.15 to 0.30; and the molar ratio between the hydrolysable silicon alkoxide and the surfactant of formula (II), preferably polyethylene (20) oxide hexadecyl ether, is comprised from 7 to 11.5.

In an embodiment, optionally in combination with one or more features of the various embodiments described above or below, in step a) the molar ratio between the hydrolysable silicon alkoxide and the aqueous solution of at least one acid catalyst is comprised from 0.35 to 0.75; the molar ratio between the hydrolysable silicon alkoxide and the C₁-C₈ alcohol is comprised from 0.15 to 0.20; and the molar ratio between the hydrolysable silicon alkoxide and the surfactant of formula (II), preferably polyethylene (20) oxide hexadecyl ether, is comprised from 8 to 9.5.

In an embodiment, optionally in combination with one or more features of the various embodiments described above or below, in step a) the molar ratio of the hydrolysable silicon alkoxide, the aqueous solution of at least one acid catalyst, the C₁-C₈ alcohol and the surfactant of formula (II), preferably polyethylene (20) oxide hexadecyl ether, is 1:2.7:6.1:0.12.

In an embodiment, optionally in combination with one or more features of the various embodiments described above or below, in step a) the resulting mixture is maintaining under stirring at a temperature comprised from 50° C. to 120° C. for an appropriate period of time and finally cooling the mixture until reaching a temperature comprised from 30° C. to 50° C. In an embodiment, optionally in combination with one or more features of the various embodiments described above or below, in step a) the resulting mixture is maintaining under stirring at a temperature comprised from 50° C. and 85° C. for a period of time comprised from 70 min to 120 min.

In an embodiment, optionally in combination with one or more features of the various embodiments described above or below, step a) is performed wherein the hydrolysable silicon alkoxide is tetraethylorthosilicate (TEOS), the C₁-C₈ alcohol is ethanol; the aqueous solution of at least one acid catalyst is an aqueous solution of HCl, the compound of formula (II) is polyethylene (20) oxide hexadecyl ether, and the concentration of polyethylene (20) oxide hexadecyl ether in the first mixture is comprised from 150 g/L to 300 g/L; and step a) is performed by maintaining the mixture at a temperature comprised from 50° C. and 85° C. for a period of time comprised from 70 min to 120 min; and finally, cooling the mixture until reaching a temperature comprised from 30° C. to 50° C.

As it is disclosed above, the process of the first aspect of the invention comprises preparing also a second mixture (step b) by a process which comprises mixing one or more C₁-C₈ alcohols, and an aqueous solution of at least one acid catalyst; and maintaining the resulting mixture at a temperature comprised from 15° C. to 30° C. for an appropriate period of time, preferably for a period of time comprised from 5 min to 30 min.

All the embodiments disclosed above for step a) in relation to the (C₁-C₈)alcohols, and the aqueous solution of at least one acid catalyst also applies for step b) of the process of the first aspect of the invention.

In an embodiment, optionally in combination with one or more features of the various embodiments described above or below, step b) is performed wherein (C₁-C₈)alcohol is ethanol, and the aqueous solution of at least one acid catalyst is an aqueous solution of HCl; particularly HCl 0.1M. In an embodiment, the acid catalyst is in form of an aqueous solution having a pH lower than 5; preferably comprised from 0 to 3.

In an embodiment, optionally in combination with one or more features of the various embodiments described above or below, in step b) the resulting mixture is maintained at a temperature comprised from 15° C. to 30° C.; preferably for a period of time comprised from 5 min to 30 min.

In a particular embodiment, optionally in combination with one or more features of the various embodiments described above or below, in step b) the (C₁-C₈)alcohol is ethanol, and the aqueous solution of at least one acid catalyst is an aqueous solution of HCl; particularly an aqueous solution of HCl 0.1M, and the resultant mixture is maintained at a temperature comprised from 15° C. to 30° C. for a period of time comprised from 5 min to 30 min.

As it is disclosed above the process of the first aspect of the invention also comprises performing step c) which comprises adding the second mixture obtained in step b) to the resulting mixture of step a); and maintaining the resulting mixture at a temperature comprised from 30° C. to 50° C. for an appropriate period of time; preferably comprised from 50 min to 90 min and d) cooling the resulting mixture obtained in step c) until reaching a temperature comprised from 15° C. to 30° C.; and adding one or more (C₁-C₈)alcohols until the molar ratio between the hydrolysable silicon alkoxide and the (C₁-C₈)alcohol is comprised from 0.025 to 0.100; wherein: the concentration in the anti-reflective sol-gel coating composition of the surfactant of formula (II) as defined above, preferably polyethylene (20) oxide hexadecyl ether is comprised from 55 g/L to 90 g/L; the molar ratio between the hydrolysable silicon alkoxide and the aqueous solution of the at least one acid catalyst is comprised from 0.050 to 0.350, and the molar ratio between the hydrolysable silicon alkoxide and the surfactant of formula (II) as defined above, preferably polyethylene (20) oxide hexadecyl ether, is comprised from 7 to 11.5.

In an embodiment, optionally in combination with one or more features of the various embodiments described above or below, the process of the first aspect of the invention also comprises performing step c) which comprises adding the second mixture obtained in step b) to the resulting mixture of step a); and maintaining the resulting mixture at a temperature comprised from 30° C. to 50° C. for an appropriate period of time; preferably comprised from 50 min to 90 min and d) cooling the resulting mixture obtained in step c) until reaching a temperature comprised from 15° C. to 30° C.; and adding one or more (C₁-C₈)alcohols until the molar ratio between the hydrolysable silicon alkoxide and the (C₁-C₈)alcohol is comprised from 0.025 to 0.050; wherein: the concentration in the anti-reflective sol-gel coating composition of the surfactant of formula (II) as defined above, preferably polyethylene (20) oxide hexadecyl ether is comprised from 55 g/L to 90 g/L; and the molar ratio between the hydrolysable silicon alkoxide and the aqueous solution of the at least one acid catalyst is comprised from 0.125 to 0.250, and the molar ratio between the hydrolysable silicon alkoxide and the surfactant of formula (II) as defined above, preferably polyethylene (20) oxide hexadecyl ether, is comprised from 8 to 9.5. In an embodiment, optionally in combination with one or more features of the various embodiments described above or below, the molar ratios of the hydrolysable silicon alkoxide, the aqueous solution of the at least one acid catalyst, the (C₁-C₈)alcohols and the surfactant of formula (II) as defined above, preferably polyethylene (20) oxide hexadecyl ether, is 1:8:24.4:0.12 for anti-reflective sol-gel coating composition of the third aspect of the invention and the molar ratios of the hydrolysable silicon alkoxide, the aqueous solution of the at least one acid catalyst, the (C₁-C₈)alcohols and the surfactant of formula (II) as defined above, preferably polyethylene (20) oxide hexadecyl ether, is 1:8:34:0.12 for anti-reflective and water-repellent sol-gel coating composition of the fourth aspect of the invention.

All the embodiments disclosed above for steps a) and b) in relation to the (C₁-C₈)alcohols also apply for step c) of the process of the first aspect of the invention.

In an embodiment, optionally in combination with one or more features of the various embodiments described above or below, in step d) the resulting mixture obtained in step c) is cooled until a temperature comprised from 15° C. to 30° C.; particularly until reaching room temperature; and adding one or more (C₁-C₈)alcohols as defined above until the molar ratio between the hydrolysable silicon alkoxide and the (C₁-C₈)alcohol is comprised from 0.025 to 0.100; preferably comprised from 0.025 to 0.050. For the purpose of the present invention, the term “room temperature” refers to a temperature comprised from 20° C. to 25° C.

All the embodiments disclosed above for steps a) and b) in relation to the (C₁-C₈)alcohols also apply for step d) of the process of the first aspect of the invention. In an embodiment, optionally in combination with one or more features of the various embodiments described above or below, step d) is performed by cooling the resulting mixture obtained in step c) until a temperature comprised from 20° C. to 25° C.; and adding ethanol until the molar ratio between the hydrolysable silicon alkoxide and the ethanol is comprised from 0.025 to 0.100, preferably comprised from 0.025 to 0.050.

In an embodiment, optionally in combination with one or more features of the various embodiments described above or below, the process for preparing an antireflective sol-gel coating composition comprises: a) first mixing tetraethylorthosilicate (TEOS), ethanol, an aqueous solution of HCl; and polyethylene (20) oxide hexadecyl ether; then maintaining the resulting mixture at a temperature comprised from 50° C. and 85° C. for a period of time comprised from 70 min to 120 min and finally cooling the mixture until reaching a temperature comprised from 30° C. to 50° C. wherein: the concentration of polyethylene (20) oxide hexadecyl ether in the resulting first mixture is comprised from 150 g/L to 300 g/L preferably 155 g/L to 280 g/L, preferably comprised from 205 g/L to 240 g/L; and the molar ratio between the hydrolysable silicon alkoxide and the acid catalyst is comprised from 0.15 to 1; the molar ratio between the hydrolysable silicon alkoxide and the (C₁-C₈)alcohol is comprised from 0.15 to 0.30, and the molar ratio between the hydrolysable silicon alkoxide and the polyethylene (20) oxide hexadecyl ether is comprised from 7 to 11.5; b) preparing a second mixture by mixing ethanol, and an aqueous solution of HCl; and maintaining the resulting mixture at a temperature comprised from 15° C. to 30° C.; preferably for a period of time comprised from 5 min to 30 min; c) adding the second mixture obtained in step b) to the resulting mixture of step a); and maintaining the resulting mixture at a temperature comprised from 20° C. to 60° C. for a period of time comprised from 50 min to 90 min; d) cooling the resulting mixture obtained in step c); and adding ethanol until the molar ratio between the hydrolysable silicon alkoxide and the ethanol is comprised from 0.025 to 0.100; wherein: the concentration of polyethylene (20) oxide hexadecyl ether in the anti-reflective sol-gel coating composition is comprised from 55 g/L to 90 g/L; the molar ratio between the hydrolysable silicon alkoxide and the acid catalyst is comprised from 0.050 to 0.350 preferably comprised from 0.125 to 0.250, and the molar ratio between the hydrolysable silicon alkoxide and the polyethylene (20) oxide hexadecyl ether is comprised from 7 to 11.5 preferably comprised from 8 to 9.5.

In a particular embodiment, optionally in combination with one or more features of the various embodiments described above or below, the process for preparing an antireflective sol-gel coating composition comprises: a) first mixing tetraethylorthosilicate (TEOS), ethanol, an aqueous solution of HCl; and polyethylene (20) oxide hexadecyl ether; then maintaining the resulting mixture at a temperature comprised from 60° C. to 85° C. for a period of time of 90 min and finally cooling the mixture until reaching a temperature of 40° C. wherein: the concentration of polyethylene (20) oxide hexadecyl ether in the resulting first mixture is comprised from 150 g/L to 300 g/L; and the molar ratio between the hydrolysable silicon alkoxide and the acid catalyst is comprised from 0.15 to 1; the molar ratio between the hydrolysable silicon alkoxide and the (C₁-C₈)alcohol is comprised from 0.15 to 0.30, and the molar ratio between the hydrolysable silicon alkoxide and the polyethylene (20) oxide hexadecyl ether is comprised from 7 to 11.5; b) preparing a second mixture by mixing ethanol, and an aqueous acidic solution of HCl; and maintaining the resulting mixture at room temperature for 10 min; c) adding the second mixture obtained in step b) to the resulting mixture of step a); and maintaining the resulting mixture at 40° C. for 60 min; d) cooling the resulting mixture obtained in step c) until reaching a temperature comprised from 15° C. to 30° C.; and adding ethanol until the molar ratio between the hydrolysable silicon alkoxide and the ethanol is comprised from 0.025 to 0.100, preferably comprised from 0.025 to 0.05; wherein the concentration of polyethylene (20) oxide hexadecyl ether in the resulting first mixture is comprised from 55 g/L to 90 g/L; preferably 75 g/L to 90 g/L; and the molar ratio between the hydrolysable silicon alkoxide and the acid catalyst is comprised from 0.050 to 0.350, preferably comprised from 0.125 to 0.250; and the molar ratio between the hydrolysable silicon alkoxide and the polyethylene (20) oxide hexadecyl ether is comprised from 7 to 11.5; preferably comprised from 8 to 9.5.

In an embodiment, optionally in combination with one or more features of the various embodiments described above or below, the process for preparing an antireflective sol-gel coating composition comprises: a) first mixing tetraethylorthosilicate (TEOS), ethanol, an aqueous solution of HCl; and polyethylene (20) oxide hexadecyl ether; then maintaining the resulting mixture at a temperature comprised from 50° C. and 85° C. for a period of time comprised from 70 min to 120 min and finally cooling the mixture until reaching a temperature comprised from 30° C. to 50° C. wherein: the concentration of polyethylene (20) oxide hexadecyl ether in the resulting first mixture is comprised from 150 g/L to 300 g/L preferably 155 g/L to 280 g/L, preferably comprised from 205 g/L to 240 g/L; and the molar ratio between the hydrolysable silicon alkoxide and the acid catalyst is comprised from 0.15 to 1; the molar ratio between the hydrolysable silicon alkoxide and the (C₁-C₈)alcohol is comprised from 0.15 to 0.30, and the molar ratio between the hydrolysable silicon alkoxide and the polyethylene (20) oxide hexadecyl ether is comprised from 7 to 11.5; b) preparing a second mixture by mixing ethanol, and an aqueous solution of HCl; and maintaining the resulting mixture at a temperature comprised from 15° C. to 30° C.; preferably for a period of time comprised from 5 min to 30 min; c) adding the second mixture obtained in step b) to the resulting mixture of step a); and maintaining the resulting mixture at a temperature comprised from 20° C. to 60° C. for a period of time comprised from 50 min to 90 min; d) cooling the resulting mixture obtained in step c); and adding ethanol until the molar ratio between the hydrolysable silicon alkoxide and the ethanol is comprised from 0.025 to 0.100; wherein: the concentration of polyethylene (20) oxide hexadecyl ether in the anti-reflective sol-gel coating composition is comprised from 55 g/L to 90 g/L; the molar ratio between the hydrolysable silicon alkoxide and the ethanol is comprised from 0.025 to 0.050; the molar ratio between the hydrolysable silicon alkoxide and the acid catalyst is comprised from 0.125 to 0.250; and the molar ratio between the hydrolysable silicon alkoxide and the polyethylene (20) oxide hexadecyl ether is comprised from 8 to 9.5. More preferably, the molar ratio between the hydrolysable silicon alkoxide, the acid catalyst, the (C₁-C₈)alcohol, and the polyethylene (20) oxide hexadecyl ether is 1:8:24.4:0.12 for anti-reflective sol-gel coating composition.

The second aspect of the invention relates to a process for preparing an antireflective sol-gel water-repellent coating composition which comprises performing the process as defined in the first aspect of the invention and further comprises adding a silicon precursor having at least one non-hydrolysable substituent bonded to the silicon atom to the initial mixture of step a). The silicon precursor having at least one non-hydrolysable substituent bonded to the silicon atom allows obtaining water-repellent surfaces. Thus, step a) of the process of the first aspect of the invention comprises a) first mixing an hydrolysable silicon alkoxide, one or more (C₁-C₈)alcohols, an aqueous solution of at least one acid catalyst, one or more surfactants of formula (II) as defined above, preferably polyethylene (20) oxide hexadecyl ether, and silicon precursor having at least one non-hydrolysable substituent bonded to the silicon atom, then maintaining the resulting mixture at a temperature comprised from 50° C. to 120° C. for an appropriate period of time; preferably comprised from 70° C. to 90° C.; and finally cooling the mixture until reaching a temperature comprised from 30° C. to 50° C.; wherein: the concentration of the surfactant of formula (II) as defined above, preferably polyethylene (20) oxide hexadecyl ether, is comprised from 150 g/L to 300 g/L; and the molar ratio between the hydrolysable silicon alkoxide and the aqueous solution of at least one acid catalyst is comprised from 0.15 to 1; the molar ratio between the hydrolysable silicon alkoxide and the (C₁-C₈)alcohol is comprised from 0.15 to 0.30; the molar ratio between the hydrolysable silicon alkoxide and the surfactant of formula (II) as defined above, preferably polyethylene (20) oxide hexadecyl ether, is comprised from 7 to 11.5, and the molar ratio between the hydrolysable silicon alkoxide and the silicon precursor having at least one non-hydrolysable substituent bonded to the silicon is comprised from 50 to 150. This process is advantageous because in a single process it is possible to obtain a sol-gel coating with water-repellence properties without detrimental effect on the anti-reflection properties.

In an embodiment, optionally in combination with one or more features of the various embodiments described above or below, the silicon precursor having at least one non-hydrolysable substituent bonded to the silicon atom is a compound of formula (III):

[CF₃—(CF₂)ₙ(CH₂)ₘ]ₐ—Si(OR¹⁰)_{b} (III)

wherein each R¹⁰ is independently selected from the group consisting of (C₁-C₂₀)alkyl, (C₂-C₂₀)alkenyl and (C₂-C₂₀)alkyl-CH═CH—; m and n are independently an integer comprised from 0 to 20, a is an integer selected from 1, 2 and 3; b is an integer selected from 1, 2, and 3; and the sum of a+b is 4; or alternatively a compound of formula (IV):

[CF₃—(CF₂)ₙ(CH₂)ₘ]ₐ—SiX_{b} (IV)

wherein each X is an halogen independently selected from the group consisting of chlorine, bromine and iodine; m and n are independently an integer comprised from 0 to 20, a is an integer selected from 1, 2 and 3; b is an integer selected from 1, 2, and 3; and the sum of a+b is 4; or alternatively a compound of formula (V)

(R¹¹)ₐSi(OR¹²)_{b} (V)

wherein each R¹¹ and each R¹² is independently selected from the group consisting of (C₁-C₂₀)alkyl, (C₂-C₂₀)alkenyl and (C₂-C₂₀)alkyl-CH═CH—; a is an integer selected from 1, 2 and 3; b is an integer selected from 1, 2, and 3; and the sum of a+b is 4; or alternatively a compound of formula (VI)

[CH₃—(CH₂)ₘ]ₐ—SiX_{b} (VI)

wherein each X is an halogen independently selected from the group consisting of chlorine, bromine and iodine; m is an integer comprised from 0 to 20, a is an integer selected from 1, 2 and 3; b is an integer selected from 1, 2, and 3; and the sum of a+b is 4.

In an embodiment, optionally in combination with one or more features of the various embodiments described above or below, the silicon precursor having at least one non-hydrolysable substituent bonded to the silicon atom is a compound of formula (III-A):

CF₃—(CF₂)ₙ(CH₂)ₘ—Si(OR¹³)(OR¹⁴)(OR¹⁵) (III-A)

wherein: each one of R¹³, R¹⁴ and R¹⁵ are independently selected from the group consisting of a substituted or un-substituted (C₁-C₁₄)alkyl, (C₅-C₆)aryl, (C₂-C₁₄)alkenyl and (C₂-C₁₄)alkyl-CH═CH—; and m and n are independently an integer comprised from 0 to 20; or alternatively a compound of formula (IV-A)

CF₃—(CF₂)ₙ(CH₂)ₘ—SiX₃ (IV-A)

wherein X is an halogen independently selected from the group consisting of chlorine, bromine and iodine; preferably chlorine; and m and n are independently an integer comprised from 0 to 20; or alternatively a compound of formula (V-A)

R¹⁶Si(OR¹⁷)(OR¹⁸)(OR¹⁹) (V-A)

wherein each R¹⁶, R¹⁷, R¹⁸ and R¹⁹ are independently selected from the group consisting of (C₁-C₂₀)alkyl, (C₂-C₂₀)alkenyl and (C₂-C₂₀)alkyl-CH═CH—; or alternatively a compound of formula (VI-A)

CH₃—(CH₂)ₘ—SiX₃ (VI-A)

wherein X is an halogen independently selected from the group consisting of chlorine, bromine and iodine; preferably chlorine and m is an integer comprised from 0 to 20.

In an embodiment, optionally in combination with one or more features of the various embodiments described above or below, the silicon precursor having at least one non-hydrolysable substituent bonded to the silicon atom is a compound of formula (III) or (III-A) selected from the group consisting of triethoxy-(1H,1H,2H,2H-perfluorododecyl)silane (FAS21), trimethoxy-(1H,1H,2H,2H-perfluorododecyl)silane, triethoxy-(1H,1H,2H,2H-perfluorodecyl)silane, trimethoxy-(1H,1H,2H,2H-perfluorodecyl)silane, triethoxy-(1H,1H,2H,2H-perfluorooctyl)silane, trimethoxy-(1H,1H,2H,2H-perfluorooctyl)silane, triethoxy(3,3,3-trifluoropropyl)silane and trimethoxy(3,3,3-trifluoropropyl)silane; preferably triethoxy-(1H,1H,2H,2H-perfluorododecyl)silane (FAS21).

In an embodiment, optionally in combination with one or more features of the various embodiments described above or below, the silicon precursor having at least one non-hydrolysable substituent bonded to the silicon atom is a compound of formula (IV) or (IV-A) wherein X is chlorine. In an embodiment, optionally in combination with one or more features of the various embodiments described above or below the at least one non-hydrolysable substituent bonded to the silicon atom is a compound of formula (IV) selected from the group consisting of 1H,1H,2H,2H-perfluorododecyltrichlorosilane, 1H,1H,2H,2H-perfluorodecyltrichlorosilane, 1H,1H,2H,2H-perfluorooctyltrichlorosilane, and trichloro(3,3,3-trifluoropropyl)silane; preferably 1H,1H,2H,2H-perfluorododecyltrichlorosilane.

In an embodiment, optionally in combination with one or more features of the various embodiments described above or below, the silicon precursor having at least one non-hydrolysable substituent bonded to the silicon atom is a compound of formula (V) or (V-A). In an embodiment, optionally in combination with one or more features of the various embodiments described above or below the at least one non-hydrolysable substituent bonded to the silicon atom is a compound of formula (V) selected from the group consisting of octadecyltriethoxysilane, octadecyltrimethoxysilane, dodecyltriethoxysilane, dodecyltrimethoxysilane, octyltriethoxysilane and octyltrimethoxysilane; preferably octadecyltriethoxysilane.

In an embodiment, optionally in combination with one or more features of the various embodiments described above or below, the silicon precursor having at least one non-hydrolysable substituent bonded to the silicon atom is a compound of formula (VI) or (VI-A) wherein X is chlorine. In an embodiment, optionally in combination with one or more features of the various embodiments described above or below the at least one non-hydrolysable substituent bonded to the silicon atom is a compound of formula (VI) selected from the group consisting of trichloro(octadecyl)silane, trichlorododecylsilane and trichloro(octyl)silane; preferably trichloro(octadecyl)silane.

In an embodiment, optionally in combination with one or more features of the various embodiments described above or below, the process of the second aspect of the invention is one wherein the hydrolysable silicon alkoxide is TEOS, and the silicon precursor having at least one non-hydrolysable substituent is FAS21. In a particular embodiment, optionally in combination with one or more features of the various embodiments described above or below, the molar ratio between the hydrolysable silicon alkoxide and the silicon precursor having at least one non-hydrolysable substituent is comprised from 50 to 150. In a particular embodiment, the hydrolysable silicon alkoxide is TEOS, and the silicon precursor having at least one non-hydrolysable substituent is FAS21 and the molar ratio between the TEOS and the FAS21 is comprised from 50 to 150.

All the embodiments disclosed above for steps a)-d) of the process of the first aspect of the invention also apply for the process for preparing the anti-reflective water-repellent sol-gel coating composition of the second aspect of the invention.

In an embodiment, optionally in combination with one or more features of the various embodiments described above or below, the concentration of surfactant of formula (II) as defined above, preferably polyethylene (20) oxide hexadecyl ether, in step d) of the second aspect of the invention is comprised from 55 g/L to 70 g/L.

The anti-reflective sol-gel coating composition of the invention may be defined by its preparation process as defined above and therefore, the anti-reflective sol-gel coating composition obtainable by the process above is considered part of the invention. Thus, the third aspect of the invention relates to an anti-reflective sol-gel coating composition for coating a substrate defined in the present invention obtainable by the process comprising: a) first mixing an hydrolysable silicon alkoxide, one or more (C₁-C₈)alcohols, an aqueous solution of at least one acid catalyst; and one or more surfactants of formula (II) as defined above, preferably polyethylene (20) oxide hexadecyl ether; then maintaining the resulting mixture at a temperature comprised from 50° C. to 120° C. for an appropriate period of time; preferably comprised from 70 min to 120 min; and finally cooling the mixture until reaching a temperature comprised from 30° C. to 50° C.; wherein: the concentration in the resulting first mixture of the surfactant of formula (II) as defined above, preferably polyethylene (20) oxide hexadecyl ether, is comprised from 150 g/L to 300 g/L; and the molar ratio between the hydrolysable silicon alkoxide and the aqueous solution of at least one acid catalyst is comprised from 0.15 to 1; the molar ratio between the hydrolysable silicon alkoxide and the (C₁-C₈) alcohol is comprised from 0.15 to 0.30, and the molar ratio between the hydrolysable silicon alkoxide and the surfactant of formula (II) as defined above, preferably polyethylene (20) oxide hexadecyl ether, is comprised from 7 to 11.5; b) preparing a second mixture by mixing one or more (C₁-C₈)alcohols, and an aqueous solution of at least one acid catalyst; and maintaining the resulting mixture at a temperature comprised from 15° C. to 30° C.; c) adding the second mixture obtained in step b) to the resulting mixture of step a); and maintaining the resulting mixture at a temperature comprised from 30° C. to 50° C. for an appropriate period of time; preferably comprised from 50 min to 90 min; and d) cooling the resulting mixture obtained in step c) until reaching a temperature comprised from 15° C. to 30° C.; and adding one or more (C₁-C₈)alcohols until the molar ratio between the hydrolysable silicon alkoxide and the (C₁-C₈)alcohol in the anti-reflective sol-gel coating composition is comprised from 0.025 to 0.100; preferably comprised from 0.025 to 0.050; wherein: the concentration in the anti-reflective sol-gel coating composition of the surfactant of formula (II) as defined above, preferably polyethylene (20) oxide hexadecyl ether, is comprised from 55 g/L to 90 g/L; preferably comprised from 75 to 90 g/L; the molar ratio between the hydrolysable silicon alkoxide and the aqueous solution of at least one acid catalyst is comprised from 0.050 to 0.350; preferably comprised from 0.050 to 0.250; and the molar ratio between the hydrolysable silicon alkoxide and the surfactant of formula (II) as defined above, preferably polyethylene (20) oxide hexadecyl ether, is comprised from 7 to 11.5; preferably comprised from 8 to 9.5. All the embodiments disclosed above for steps a)-d) of the process of the first aspect of the invention also apply for the anti-reflective sol-gel coating composition obtainable by the process of the third aspect of the invention.

The anti-reflective water-repellent sol-gel coating composition of the invention may be also defined by its preparation process as defined above and therefore, the anti-reflective water-repellent sol-gel coating composition for coating a substrate obtainable by the process above is considered part of the invention. Thus, the fourth aspect of the invention relates to an anti-reflective water-repellent sol-gel coating composition defined above obtainable by the process comprising: a) first mixing an hydrolysable silicon alkoxide, one or more (C₁-C₈)alcohols, an aqueous solution of at least one acid catalyst; one or more surfactants of formula (II) as defined above, preferably polyethylene (20) oxide hexadecyl ether, and a silicon precursor having at least one non-hydrolysable substituent bonded to the silicon atom; then maintaining the resulting mixture at a temperature comprised from 50° C. to 120° C. for an appropriate period of time; preferably for a period of time comprised from 70 min to 120 min; and finally cooling the mixture until reaching a temperature comprised from 30° C. to 50° C.; wherein: the concentration in the resulting first mixture of the surfactant of formula (II) as defined above, preferably polyethylene (20) oxide hexadecyl ether, is comprised from 150 g/L to 300 g/L; the molar ratio between the hydrolysable silicon alkoxide and the aqueous solution of at least one acid catalyst is comprised from 0.15 to 1; the molar ratio between the hydrolysable silicon alkoxide and the (C₁-C₈)alcohol is comprised from 0.15 to 0.30, and the molar ratio between the hydrolysable silicon alkoxide and the surfactant of formula (II) as defined above, preferably polyethylene (20) oxide hexadecyl ether, is comprised from 7 to 11.5; b) preparing a second mixture by mixing one or more (C₁-C₈)alcohols, and an aqueous solution of at least one acid catalyst; and maintaining the resulting mixture at a temperature comprised from 15° C. to 30° C.; c) adding the second mixture obtained in step b) to the resulting mixture of step a); and maintaining the resulting mixture at a temperature comprised from 30° C. to 50° C. for an appropriate period of time; preferably comprised from 50 min to 90 min; and d) cooling the resulting mixture obtained in step c) until reaching a temperature comprised from 15° C. to 30° C.; and adding one or more (C₁-C₈)alcohols until the molar ratio between the hydrolysable silicon alkoxide and the (C₁-C₈)alcohol is comprised from 0.025 to 0.100; preferably comprised from 0.025 to 0.050; wherein: the concentration in the anti-reflective water-repellent sol-gel coating composition of the surfactant of formula (II) as defined above, preferably polyethylene (20) oxide hexadecyl ether, is comprised from 55 g/L to 90 g/L preferably comprised from 55 g/L to 70 g/L; and the molar ratio between the hydrolysable silicon alkoxide and the aqueous solution of at least one acid catalyst is comprised from 0.050 to 0.350; preferably comprised from 0.050 to 0.250; and the molar ratio between hydrolysable silicon alkoxide and the surfactant of formula (II) as defined above, preferably polyethylene (20) oxide hexadecyl ether, is comprised from 7 to 11.5; preferably comprised form 8 to 9.5; and the molar ratio between the hydrolysable silicon alkoxide and the silicon precursor having at least one non-hydrolysable substituent bonded to the silicon atom is comprised from 50 to 150.

All the embodiments disclosed above for steps a)-d) of the process of the first aspect of the invention and also step a) of the process of the second aspect of the invention also apply for the anti-reflective water-repellent sol-gel coating composition obtainable by the process of the fourth aspect of the invention.

The present invention also relates to processes for preparing a single anti-reflective coating on a substrate having enhanced anti-reflective properties and durability. Thus, the fifth aspect of the invention relates to a process for preparing a single anti-reflective coating on a substrate which comprises: e) depositing a mono-layer of the anti-reflective sol-gel coating composition as defined in the third aspect of the invention or alternatively, the anti-reflective water-repellent sol-gel coating composition as defined in the fourth aspect of the invention over the substrate; and f) sintering the coating obtained in step e).

For the purposes of the invention, the term “substrate” refers to a substantially transparent material having a refractive index comprised from 1.45 to 1.65 measured at a wavelength of 632.8 nm.

The substrate can be any transparent rigid or flexible substrate. In an embodiment, optionally in combination with one or more features of the various embodiments described above or below, the substrate is selected from the group consisting of silica glass, oxide glass and polymeric substrate.

In an embodiment, optionally in combination with one or more features of the various embodiments described above or below, the substrate is selected from the group consisting of silica glass and oxide glass substrate and it can be thermally or chemically tempered, toughened or strengthened, annealed or untreated glass, wherein the silica glass and the oxide glass is selected from the group consisting of fused quartz/fused silica glass, soda lime silica glass, low iron soda lime silica glass (also named extra clear glass), borosilicate glass, sodium borosilicate glass, alkali-barium silicate glass, aluminosilicate glass, lead-oxide glass, phosphate glass, borate glass, fluoride glass, chalcogenide glass, solar glass, optical glass, oxide composed glass, and mixture thereof.

In an embodiment, optionally in combination with one or more features of the various embodiments described above or below, the substrate is a polymeric substrate selected from the group consisting of polycarbonate polymers (PC) and poly(methyl methacrylate) (PMMA), polystyrene (PS), and mixture thereof.

In an embodiment, optionally in combination with one or more features of the various embodiments described above or below, when the substrate is silica glass or oxide glass then the process further comprises a previous step prior step e) which comprises degreasing and cleaning the glass. The degreasing and cleaning steps can be performed using the known techniques of the state of the art such as by plasma cleaning, UV-Ozone cleaning, ultrasonically cleaning and wet-chemical cleaning. In an embodiment, optionally in combination with one or more features of the various embodiments described above or below, when the substrate is silica glass or oxide glass then the process further comprises a previous step prior step e) which comprises degreasing and cleaning the glass by immersing the glass in an ultrasonic bath in the presence of a solvent such as for example (C₁-C₄) alcohol.

In an embodiment, optionally in combination with one or more features of the various embodiments described above or below, step e) of the process of the invention can be performed using the known techniques of the state of the art for depositing a coating over a substrate. In an embodiment, optionally in combination with one or more features of the various embodiments described above or below, the coating of the invention can be deposited over the substrate (step e) using a technique selected from the group consisting of spin-coating, dip-coating, spray-coating, flow-coating, roll-coating, web-coating, ink-jet printing, doctor blade coating, printing such as screen-printing, ink-jet printing, flexographic printing, gravure printing, and micro-gravure printing. In an embodiment, optionally in combination with one or more features of the various embodiments described above or below, the anti-reflective coating of the invention is deposited over the substrate (step e) by dipping the substrate in the sol-gel coating composition of the third and the fourth aspect of the invention.

In an embodiment, optionally in combination with one or more features of the various embodiments described above or below, step e) is performed by dipping the substrate in the sol-gel coating composition of the third and the fourth aspect of the invention at a deposition rate comprised from 2 cm/min to 40 cm/min; preferably the deposition rate is comprised from 2 cm/min to 10 cm/min; more preferably comprised from 2 cm/min to 6 cm/min.

As it is mentioned above, the process for preparing a single anti-reflective coating on a substrate comprises a sintering step f) after the deposition of the coating composition of the invention over the substrate. Examples of techniques appropriate for performing step f) can be, without limitation, conventional thermal sintering, or thermal sintering during glass conventional thermal tempering or conventional thermal strengthening.

In an embodiment, optionally in combination with one or more features of the various embodiments described above or below, the substrate is glass and then the sintering step f) is carried out by a conventional thermal sintering method, or alternatively by a thermal sintering during glass conventional thermal tempering or conventional thermal strengthening. In an embodiment, optionally in combination with one or more features of the various embodiments described above or below, the substrate is glass and the sintering step f) is carried out by a conventional thermal sintering method which comprises heating the coated glass at a temperature comprised from 200° C. to 700° C.; preferably comprised from 240° C. to 550° C.

In an embodiment, optionally in combination with one or more features of the various embodiments described above or below, the sintering step f) is carried out by a conventional thermal sintering at a temperature comprised from 240° C. to 350° C., and then the process further comprises an additional step f) after method f) that comprises treating the coated substrate with a solution of water and water miscible organic solvent. In an embodiment, step f) is carried out in the presence of a mixture of water and a miscible organic solvent selected from the group consisting of (C₁-C₄)alcohol, (C₁-C₄)alkyl-CO—(C₁-C₄)alkyl and mixtures thereof. Examples of appropriate alcohols for the present invention include methanol, ethanol, n-propanol, iso-propanol, butanol, iso-butanol, and sec-butanol. In an embodiment, optionally in combination with one or more features of the various embodiments described above or below, step f) is performed by immersing the coated substrate obtained in step f) in the mixture of water and the miscible organic solvent as defined above; preferably, step f′) is performed under ultrasonic activity (cavitation).

In an embodiment, optionally in combination with one or more features of the various embodiments described above or below, the substrate is glass and the sintering step f) is carried out by thermal sintering during glass conventional thermal tempering, or conventional thermal strengthening processes that involve heat treatment of annealed glass in a furnace. The thermal sintering during glass conventional thermal tempering, or conventional thermal strengthening can be performed using the known techniques of the state of the art in order to cover the requirements specified in standards: ASTM C1048 Standard specification for heat-strengthened and fully tempered flat glass; and EN 12150 Glass in building—Thermally toughened soda lime silicate safety glass. In an embodiment, the thermal sintering during glass conventional thermal tempering, or conventional thermal strengthening processes comprises heating the glass at a temperature comprised from 600° C. to 700° C.; and force-cooling the glass obtained in previous step at a temperature comprised from 20° C. to 150° C. to create surface and edge compression by air-quenching.

In an embodiment, optionally in combination with one or more features of the various embodiments described above or below, the substrate is a polymeric substrate and then the sintering step f) is carried out by a conventional thermal sintering method, photochemical treatments (such as ultraviolet or infrared treatments), or microwave treatment. In an embodiment, optionally in combination with one or more features of the various embodiments described above or below, the substrate is polymeric substrate and the sintering step f) is carried out by a conventional thermal sintering method which comprises heating the polymeric substrate at a temperature comprised from 200° C. to 275° C.

Furthermore, the sixth aspect of the invention relates to a process for preparing an anti-reflective multi-layer stack on a substrate which comprises: g) firstly, depositing an inner layer over the substrate by a process which comprises: g1) providing a sol-gel coating composition obtainable by a process which comprises: g1a) first mixing an hydrolysable silicon alkoxide, one or more (C₁-C₈)alcohols, and an aqueous solution of at least one acid catalyst; then maintaining the resulting mixture at a temperature comprised from 50° C. to 120° C. for an appropriate period of time; preferably comprised from 70 min to 120 min; and finally cooling the mixture until reaching a temperature comprised from 30° C. to 50° C.; g1b) preparing a second mixture by mixing one or more (C₁-C₈)alcohols, and an aqueous solution of at least one acid catalyst; and maintaining the resulting mixture at a temperature comprised from 15° C. to 30° C. for an appropriate period of time; preferably for a period of time comprised from 5 min to 30 min; g1c) adding the second mixture obtained in step g1b) to the resulting mixture of step g1a); and maintaining the resulting mixture at a temperature comprised from 30° C. to 50° C. for an appropriate period of time; preferably comprised from 50 min to 90 min; g2) depositing the sol-gel coating composition over the substrate; and g3) drying or sintering the coating obtained in step g2); and h) secondly, depositing an external anti-reflective layer over the inner layer on the substrate, by a process which comprises: h1) depositing the anti-reflective sol-gel coating composition as defined in the third aspect of the invention; or alternatively, the anti-reflective water-repellent sol-gel coating composition as defined in the fourth aspect of the invention, over the inner layer on the substrate; and h2) sintering the coating obtained in step h1), to obtain an anti-reflective multi-layer stack on a substrate formed by a first inner layer of a sol-gel coating composition and a second external layer (deposited onto the inner layer) of an anti-reflective sol-gel coating composition of the invention, or alternatively a second external layer (deposited on the inner layer) of an anti-reflective water-repellent sol-gel coating composition of the invention.

In an embodiment, optionally in combination with one or more features of the various embodiments described above or below, step g3) is performed by drying at a temperature comprised from 100° C. to 200° C. In an embodiment, optionally in combination with one or more features of the various embodiments described above or below, step g3) is performed by sintering the coating obtained in step g2) by conventional thermal sintering, or alternatively thermal sintering during glass conventional thermal tempering, toughening or thermal strengthening. In an embodiment, optionally in combination with one or more features of the various embodiments described above or below, step g3) is performed by conventional thermal sintering at a temperature comprised from 200 to 700° C., preferably comprised from 350° C. to 550° C. In an embodiment, optionally in combination with one or more features of the various embodiments described above or below, step g3) is performed by thermal sintering during glass conventional thermal tempering, or conventional thermal strengthening following a process that comprises heating the glass at a temperature comprised from 600° C. to 700° C.; and force-cooling the glass obtained in previous step at a temperature comprised from 20° C. to 150° C. to create surface and edge compression by air-quenching.

In an embodiment, optionally in combination with one or more features of the various embodiments described above or below, the process for preparing a multi-layer stack coated substrate as defined above is that wherein the second external layer (deposited on the inner layer) of a sol-gel anti-reflective coating composition of the invention and the sintering step g3) is carried out by a conventional thermal sintering or alternatively by thermal sintering during glass conventional thermal tempering or conventional thermal strengthening as defined above. In an embodiment, optionally in combination with one or more features of the various embodiments described above or below, the process for preparing an anti-reflective multi-layer stack on a substrate as defined above is that wherein the second external layer (deposited on the inner layer) is an anti-reflective water-repellent sol-gel coating composition of the invention and the sintering step is carried out by conventional thermal sintering.

In an embodiment, optionally in combination with one or more features of the various embodiments described above or below, when the substrate is glass then the process further comprises a previous step prior step g) which comprises degreasing and cleaning the glass. The degreasing and cleaning steps can be performed using the known techniques of the state of the art as defined above in the present invention.

In an embodiment, optionally in combination with one or more features of the various embodiments described above or below, the process for preparing an anti-reflective multi-layer stack on a substrate as defined above is that wherein the sintering step h2) is carried out by a conventional thermal sintering or alternatively by thermal sintering during glass conventional thermal tempering or conventional thermal strengthening as defined above.

In an embodiment, optionally in combination with one or more features of the various embodiments described above or below, the process for preparing an anti-reflective multi-layer stack on a substrate as defined above is that wherein step g3) is performed by thermal sintering during glass conventional thermal tempering or conventional thermal strengthening and step h2) is performed by a conventional thermal sintering at a temperature comprised from 200° C. to 250° C.

All embodiments disclosed above for steps a)-d) of the process of the first aspect of the invention also apply for steps g) and h) of the process of the sixth aspect of the invention. Further, all embodiments disclosed above for steps e) and f) of the process of the fifth aspect of the invention also apply for steps g) and h).

In an embodiment, optionally in combination with one or more features of the various embodiments described above or below, the process of the invention is that wherein step g) is performed by depositing a first inner layer over the substrate by a process which comprises: g1) providing a sol-gel coating composition obtainable by a process which comprises: g1a) first mixing TEOS, ethanol and an aqueous solution of HCl; then maintaining the resulting mixture at a temperature comprised from 50° C. and 70° C. for a period of time comprised from 70 min to 120 min; and finally cooling the mixture until reaching a temperature comprised from 30° C. to 50° C.; g1b) preparing a second mixture by mixing ethanol, and an aqueous solution of HCl; and maintaining the resulting mixture at a temperature comprised from 15° C. to 30° C. for a period of time comprised from 5 min to 30 min; g1c) adding the second mixture obtained in step g1b) to the resulting mixture of step g1a); and maintaining the resulting mixture at a temperature comprised from 30° C. to 50° C. for an appropriate period of time; preferably comprised from 50 min to 90 min; g2) depositing the sol-gel coating composition over the substrate; and g3) drying or alternatively sintering the coating obtained in step g2).

In an embodiment, optionally in combination with one or more features of the various embodiments described above or below, the process of the invention is that wherein step h) is performed by depositing an external anti-reflective layer over the inner layer on the substrate, by a process which comprises: h1) depositing the anti-reflective sol-gel coating composition as defined in the third aspect of the invention; or alternatively, the anti-reflective water-repellent sol-gel coating composition as defined in the fourth aspect of the invention, over the inner layer on the substrate; and h2) sintering the coating obtained in step h1).

In an embodiment, optionally in combination with one or more features of the various embodiments described above or below, the process for preparing a single anti-reflective coating on a substrate of the fifth aspect of the invention further comprises an additional step i) after step f); or alternatively the process further comprises additional step ii) after step f); or alternatively the process further comprises additional step i) after step f) followed by step ii); or alternatively the process further comprises additional step ii) after step f) followed by step i); wherein: step i) comprises depositing one or more additional coating over the external coating of the substrate; and step ii) comprises surface functionalization of the external coating of the substrate.

In an embodiment, optionally in combination with one or more features of the various embodiments described above or below, the process for preparing an anti-reflective multi-layer stack on a substrate of the sixth aspect of the invention further comprises an additional step i) after step h); or alternatively the process further comprises additional step ii) after step h); or alternatively the process further comprises additional step i) after step h) followed by step ii); or alternatively the process further comprises additional step ii) after step h) followed by step i); wherein: step i) comprises depositing one or more additional coating over the external coating of the substrate; and step ii) comprises surface functionalization of the external coating of the substrate.

In an embodiment, processes of the fifth and sixth aspect of the invention further comprises additional step i) or alternatively additional step ii) as defined above.

In an embodiment, optionally in combination with one or more features of the various embodiments described above or below, the process for preparing a single anti-reflective coating on a substrate of the fifth aspect of the invention further comprises an additional step i) after step f). In an alternative embodiment, optionally in combination with one or more features of the various embodiments described above or below, the process for preparing a single anti-reflective coating on a substrate of the fifth aspect of the invention further comprises additional step ii) after step f).

In an embodiment, optionally in combination with one or more features of the various embodiments described above or below, the process for preparing an anti-reflective multi-layer stack on a substrate of the sixth aspect of the invention further comprises an additional step i) after step h). In an alternative embodiment, optionally in combination with one or more features of the various embodiments described above or below, the process for preparing an anti-reflective multi-layer stack on a substrate of the sixth aspect of the invention further comprises additional step ii) after step h).

In an embodiment, processes of the fifth and sixth aspect of the invention further comprises additional steps i) and step ii) in any order.

In an embodiment, optionally in combination with one or more features of the various embodiments described above or below, the process for preparing a single anti-reflective coating on a substrate of the fifth aspect of the invention further comprises additional step i) after step f) followed by step ii). In an alternative embodiment, optionally in combination with one or more features of the various embodiments described above or below, the process for preparing a single anti-reflective coating on a substrate of the fifth aspect of the invention further comprises additional step ii) after step f) followed by step i).

In an embodiment, optionally in combination with one or more features of the various embodiments described above or below, the process for preparing an anti-reflective multi-layer stack on a substrate of the sixth aspect of the invention further comprises additional step i) after step h) followed by step ii). In an alternative embodiment, optionally in combination with one or more features of the various embodiments described above or below, the process for preparing an anti-reflective multi-layer stack on a substrate of the sixth aspect of the invention further comprises additional step ii) after step h) followed by step i).

Step i) can be performed using the known techniques of the state of the art for depositing a coating over a substrate, for example deposition of pure or mixed ceramic coating by sol-gel technique, deposition of metal coating by electroless plating and sputtering deposition. In an embodiment, optionally in combination with one or more features of the various embodiments described above or below, step i) comprises depositing one or more additional ceramic or mixed ceramic materials over the external sintered coating of the substrate of the present invention.

Step ii) can be performed using the known techniques of the state of the art for surface functionalisation, for instance by wet techniques based on solutions containing chemical precursors or alternatively by dry techniques such as for example Chemical Vapour Deposition or plasma assisted technologies. In an embodiment, optionally in combination with one or more features of the various embodiments described above or below, step ii) is performed by silylation or hydrocarbonation or fluorocarbonation of the resulting coated substrate; preferably silylation with one or more silylating agent. The treatment with silylating agent allows reducing the number of free silanol groups (Si—OH) in the surface of the coated substrate and permits to functionalise surface by attaching organic groups to Si thus permitting to obtain hydrophobic or superhydrophobic surfaces. In an embodiment, optionally in combination with one or more features of the various embodiments described above or below, step ii) comprises surface functionalisation over the external sintered coating of the substrate of the present invention such as for example organosilicon, hydrocarbon and/or fluorocarbon functionalization by wet or dry technologies.

In an embodiment, step ii) comprises reacting the surface of the coated substrate with a silylating compound optionally followed by a thermal drying step. In embodiment, the step ii) is performed by reacting the surface of the coated substrate with a mixture of a silylating compound with an organic solvent optionally followed by a thermal drying step; preferably the organic solvent is selected from (C₁-C₈)alcohol, linear or branched (C₅-C₁₆)alkane, and cycloalkane preferably the organic solvent is a (C₁-C₈)alcohol selected from ethanol, iso-propanol, and n-propanol; more preferably n-propanol.

In an embodiment, the silylating compound used in step ii) is selected from the group consisting of a compound of formula (VII)

R²⁰R²¹R²²Si—R²³ (VII)

or alternatively a compound of formula (VIII)

R²⁴R²⁵R²⁶—Si—Z—Si—R²⁷R²⁸R²⁹ (VIII)

wherein R²⁰, R²¹, R²², R²⁴, R²⁵, R²⁶, R²⁷, R²⁸ and R²⁹ are independently selected from the group consisting of substituted or unsubstituted (C₁-C₁₄)alkyl, (C₅-C₆)aryl, (C₂-C₁₄)alkenyl and (C₂-C₁₄)alkynyl group; substituted or unsubstituted fluoro-(C₁-C₁₄)alkyl, fluoro-(C₅-C₆)aryl, fluoro-(C₂-C₁₄)alkenyl and fluoro-(C₂-C₁₄)alkynyl group; R²³ is selected from the group consisting of halogen, (C₅-C₆)aryl, —NH₂, —NHR³⁰, —N(R³¹)₂, —NH—CO—(C₁-C₆)alkyl, and —NH—CO—CF₃; each R³⁰ and each R³¹ are independently selected from the group consisting of substituted or unsubstituted (C₁-C₁₄)alkyl, (C₅-C₆)aryl, (C₂-C₁₄)alkenyl and (C₂-C₁₄)alkynyl; Z is selected from the group consisting of —NH—, —N(C₁-C₆)alkyl-, —N(C₁-C₆)alkyl-O—, —N-fluoro-(C₁-C₆)alkyl-O—, —N(C₁-C₆)alkyl-O—), —NH—CO—O—, —NH—O—, —N(C₁-C₆)alkyl-, —O—SO₂—O—, —N-fluoro-(C₁-C₆)alkyl-O—, —NH—CO—NH—. In an embodiment, optionally in combination with one or more features of the various embodiments described above or below, the silylating agent used in step ii) is selected from the group consisting of trimethylchlorosilane (TMCS), trimethylbromosilane (TMBS), trimethyliodosilane (TMIS), trimethylsilylimidazole (TMSI), N-Trimethylsilyldimethylamine (TMSDMA),N-trimethylsilyldiethylamine (TMSDEA), N-trimethylsilylacetamide (TMSA), N-methyl-N-trimethyl-silyltrifluoroacetamide (MSTFA), hexamethyldisilazane (HMDS), N,O-Bis-(trimethylsilyl)-acetamide (BSA), N,O-Bis-(trimetylsilyl)-trifluoroacetamide (BSTFA), N,O-Bis(trimethylsilyl)carbamate (BSC), N, N-Bis(trimethylsilyl)formamide (BSF), N,N-Bis(trimethylsilyl)methylamine, Bis(trimethylsilyl) sulfate (BSS), N,N′-Bis(trimethylsilyl)urea (BSU) and mixture thereof.

In an embodiment, the thermal drying step of step ii) is performed at a temperature comprised from 80° C. and 250° C.

In an embodiment, step ii) is performed by adding a solution of n-propanol and a silylating agent as defined above, preferably HMDS, followed by thermal drying at a temperature comprised between 80° C. and 250° C.

In an embodiment, optionally in combination with one or more features of the various embodiments described above or below, the processes of the fifth and the sixth aspect of the invention are performed by applying the sol-gel coating compositions as define above onto one or both sides of the substrate.

The single anti-reflective coating on a substrate of the invention may be defined by its preparation process as defined above and therefore, the anti-reflective coating on a substrate obtainable by the process above is considered part of the invention. Thus, a single anti-reflective coating on a substrate which comprises: e) depositing a mono-layer of the anti-reflective sol-gel coating composition as defined in the third aspect of the invention over the substrate or the anti-reflective water-repellent sol-gel coating composition of the fourth aspect of the invention over a substrate; and f) sintering the coating obtained in step e) and optionally further comprises an additional step i) after step f); or alternatively the process further comprises additional step ii) after step f); or alternatively the process further comprises additional step i) after step f) followed by step ii); or alternatively the process further comprises additional step ii) after step f) followed by step i); wherein: step i) comprises depositing one or more additional coating over the external coating of the substrate; and step ii) comprises surface functionalization of the external coating of the substrate to obtain an anti-reflective coating as a mono-layer on a substrate having anti-reflective properties is also part of the invention.

The anti-reflective multi-layer stack on a substrate of the invention may be defined by its preparation process as defined above and therefore, the coated substrates obtainable by the process above is considered part of the invention. Thus, an anti-reflective multi-layer stack on a substrate which comprises: g) firstly, depositing an inner layer over the substrate by a process which comprises: g1) providing a sol-gel coating composition obtainable by a process which comprises: g1a) first mixing an hydrolysable silicon alkoxide, one or more (C₁-C₈)alcohols, and an aqueous solution of at least one acid catalyst; then maintaining the resulting mixture at a temperature comprised from 50° C. to 120° C. for an appropriate period of time; preferably comprised from 70 min to 120 min and finally cooling the mixture until reaching a temperature comprised from 30° C. to 50° C.; g1b) preparing a second mixture by mixing one or more (C₁-C₈)alcohols, and an aqueous solution of at least one acid catalyst; and maintaining the resulting mixture at a temperature comprised from 15° C. to 30° C. for an appropriate period of time; preferably comprised from 5 min to 30 min; g1c) adding the second mixture obtained in step g1b) to the resulting mixture of step g1a); and maintaining the resulting mixture at a temperature comprised from 30° C. to 50° C. for an appropriate period of time; preferably comprised from 50 min to 90 min; g2) depositing the sol-gel coating composition over the substrate; and g3) drying or alternatively sintering the coating obtained in step g2); and h) secondly, depositing an external anti-reflective layer over the inner layer on the substrate, by a process which comprises: h1) depositing the anti-reflective sol-gel coating composition as defined in the third aspect of the invention; or alternatively, the anti-reflective water-repellent sol-gel coating composition as defined in the fourth aspect of the invention, over the inner layer on the substrate; and h2) sintering the coating obtained in step h1), and optionally further comprises an additional step i) after step h); or alternatively the process further comprises additional step ii) after step h); or alternatively the process further comprises additional step i) after step h) followed by step ii); or alternatively the process further comprises additional step ii) after step h) followed by step i); wherein: step i) comprises depositing one or more additional coating over the external coating of the substrate; and step ii) comprises surface functionalization of the external coating of the substrate to obtain an anti-reflective multi-layer stack on a substrate formed by a first inner layer of a sol-gel coating composition and a second external layer (deposited on the inner layer) of a sol-gel anti-reflective coating composition of the invention or alternatively a second external layer (deposited on the inner layer) of a sol-gel anti-reflective water-repellent coating composition of the invention is also part of the invention.

All the embodiments disclosed above for the steps e)-f), g)-h) and i)-ii) of the process of preparing the coated substrates also apply for the coated substrates obtainable by the process of the fifth and sixth aspect of the invention. Furthermore, all the embodiments disclosed above for the substrate also apply for the coated substrate obtainable by the process of the fifth and sixth aspect of the invention.

In an embodiment, optionally in combination with one or more features of the various embodiments described above or below, the single anti-reflective coating on a substrate is a mono-layer having a thickness comprised from 100 nm to 140 nm and a refractive index comprised from 1.20 to 1.26 at a wavelength of 700 nm which is obtainable by the process as defined in fifth aspect of the invention, wherein the hydrolysable silicon alkoxide is tetraethylorthosilicate (TEOS), the (C₁-C₈)alcohol is ethanol, and the aqueous solution of an acid catalyst is an aqueous solution of HCl, and the surfactant of formula (II) is polyethylene (20) oxide hexadecyl ether.

In an embodiment, optionally in combination with one or more features of the various embodiments described above or below, the anti-reflective multi-layer stack on a substrate is a bi-layer stack wherein the external layer of the stack has a thickness comprised from 100 nm to 140 nm and a refractive index comprised from 1.20 to 1.26 at a wavelength of 700 nm; and the inner layer of the stack has a thickness comprised from 95 nm to 150 nm and a refractive index comprised from 1.42 to 1.48 at a wavelength of 700 nm, which is obtainable by the process as defined in the sixth aspect of the invention, wherein the hydrolysable silicon alkoxide is tetraethylorthosilicate (TEOS), the (C₁-C₈)alcohol is ethanol, the acid catalyst is an aqueous acidic solution of HCl and the surfactant of formula (II) is polyethylene (20) oxide hexadecyl ether.

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention. The following examples and drawings are provided by way of illustration, and they are not intended to be limiting of the present invention. Reference signs related to drawings and placed in parentheses in a claim, are solely for attempting to increase the intelligibility of the claim, and shall not be construed as limiting the scope of the claim. Furthermore, the present invention covers all possible combinations of particular and preferred embodiments described herein.

### Examples

### Abbreviation

TEOS: tetraethylorthosilicate
FAS21: triethoxy-(1H,1H,2H,2H-perfluorododecyl)silane
HMDS: hexamethyldisilazane
BEMA: Bruggeman effective medium approximation
Brij58: polyethylene (20) oxide hexadecyl ether, poly(oxyethylene) cetyl ether, poly(oxyethylene)palmityl ether, polyethylene oxide hexadecyl ether, polyethylene glycol cetyl ether; CAS number 9004-95-9
Triton X-100: t-octylphenoxypolyethoxyethanol, polyethylene glycol tert-octylphenyl ether, polyoxyethylene (10) isooctylphenyl ether; CAS number 9002-93-1
CTAB: Cetyltrimethylammonium bromide; CAS number 57-09-0
Pluronic F127: 2-methyloxirane; 1,2-propyleneglycol ethoxylated and propoxylated; CAS number 9003-11-6

### 1. Sol-Gel Coating Composition

### 1A—Composition

### Composition of Sols

Tables 1A, 1B and 1C show the quantitative components intervening in the preparation of the sol-gel coating compositions of the present invention, where the amount of the ingredients is expressed in molar ratio. In those Tables it is also shown the concentration of polyethylene (20) oxide hexadecyl ether expressed in grams of polyethylene (20) oxide hexadecyl ether per litre of SOL.

### Composition of the SOL 1

Table 1A shows the quantitative components intervening in the preparation of the sol 1 of the present invention which comprises polyethylene (20) oxide hexadecyl ether as a surfactant:

TABLE 1A

| Ingredients | | Examples | | |
|---|---|---|---|---|
| Function | Name | 1 | 2 | 3 |
| Hydrolysable silicon | TEOS | 1 | 1 | 1 |
| alkoxide | | | | |
| Aqueous solution | HCl 0.1M | 4 | 8 | 8 |
| of at least on | | | | |
| acid catalyst | | | | |
| Surfactant | polyethylene (20) | 0.1073 | 0.1170 | 0.1233 |
| | oxide hexadecyl | (75 g/L) | (75 g/L) | (77.6 g/L) |
| | ether (Brij58) | | | |
| (C₁-C₈)alcohol | Ethanol | 22.5 | 23.7 | 24.4 |

### Composition of the SOL 2

Table 1B shows the quantitative components intervening in the preparation of the SOL 2 of the present invention which comprises polyethylene (20) oxide hexadecyl ether as a surfactant, and FAS21 as a water-repellent agent:

TABLE 1B

| Ingredients | | Example |
|---|---|---|
| Function | Name | 4 |
| Hydrolysable silicon alkoxide | TEOS | 1 |
| An aqueous solution of at least | HCl 0.1M | 8 |
| an acid catalyst | | |
| Surfactant | polyethylene (20) oxide | 0.123 |
| | hexadecyl ether (Brij58) | (58.9 g/L) |
| (C₁-C₈)alcohol | Ethanol | 34.0 |
| Silicon precursor having a non- | FAS21 | 0.01 |
| hydrolysable substituent bonded to | | |
| silicon atom | | |

### Composition of the SOL 3

Table 1C shows the quantitative components intervening in the preparation of the SOL 3 which they don't contain neither polyethylene (20) oxide hexadecyl ether nor FAS21 and it is used in the preparation of the anti-reflective multi-layer sol-gel stack on a substrate:

TABLE 1C

| Ingredients | | Example |
|---|---|---|
| Function | Name | 5 |
| Hydrolysable silicon alkoxide | TEOS | 1 |
| An aqueous solution of at least an acid catalyst | HCl 0.1M | 4 |
| (C₁-C₈)alcohol | Ethanol | 8.7 |

### 1.B—Comparative Composition

### Composition of Sols

Tables 2A-2E show the quantitative components intervening in the preparation of the comparative sol-gel coating compositions outside the scope of the present invention, where the amount of the ingredients is expressed in molar ratio. In those Tables it is also shown the concentration of polyethylene (20) oxide hexadecyl ether or other surfactant different from polyethylene (20) oxide hexadecyl ether expressed in grams of surfactant per litre of SOL.

### Comparative Composition of SOL 1

Tables 2A and 2B show the quantitative components intervening in the preparation of the comparative sol-gel coating composition having a concentration of polyethylene (20) oxide hexadecyl ether in SOL 1 outside the scope of the present invention.

TABLE 2A

| Ingredients | | Comparative Examples | | | | | |
|---|---|---|---|---|---|---|---|
| Function | Name | 1 | 2 | 3 | 4 | 5 | 6 |
| Hydrolysable | TEOS | 1 | 1 | 1 | 1 | 1 | 1 |
| silicon alkoxide | | | | | | | |
| An aqueous | HCl 0.1M | 4 | 8 | 4 | 8 | 4 | 8 |
| solution of at | | | | | | | |
| least an acid | | | | | | | |
| catalyst | | | | | | | |
| Surfactant | polyethylene | 0.0179 | 0.0196 | 0.0358 | 0.039 | 0.0716 | 0.0780 |
| | (20) oxide | (25 g/L) | (25 g/L) | (50 g/L) | (50 g/L) | (50 g/L) | (50 g/L) |
| | hexadecyl | | | | | | |
| | ether (Brij58) | | | | | | |
| (C₁-C₈) alcohol | ethanol | 8.7 | 8.7 | 8.7 | 8.7 | 22.5 | 23.7 |

TABLE 2B

| Ingredients | | Comparative Examples | | | |
|---|---|---|---|---|---|
| Function | Name | 7 | 8 | 9 | 10 |
| Hydrolysable silicon | TEOS | 1 | 1 | 1 | 1 |
| alkoxide | | | | | |
| An aqueous solution of at | HCl 0.1M | 4 | 8 | 4 | 8 |
| least an acid catalyst | | | | | |
| Surfactant | polyethylene | 0.0716 | 0.0780 | 0.1074 | 0.1170 |
| | (20) oxide | (100 g/L) | (100 g/L) | (150 g/L) | (150 g/L) |
| | hexadecyl | | | | |
| | ether | | | | |
| | (Brij58) | | | | |
| (C₁-C₈)alcohol | ethanol | 8.7 | 8.7 | 8.7 | 8.7 |

Tables 2C, 2D and 2E show the quantitative components intervening in the preparation of the comparative sol-gel coating compositions having as a surfactant other than polyethylene (20) oxide hexadecyl ether falling outside the scope of the present invention.

TABLE 2C

| Ingredients | Comparative Examples | | | | | |
|---|---|---|---|---|---|---|
| (Name) | 11 | 12 | 13 | 14 | 15 | 16 |
| TEOS | 1 | 1 | 1 | 1 | 1 | 1 |
| H₂SO₄ 0.1M | 8 | 8 | 8 | 8 | 8 | 8 |
| CTAB | 0.060 | 0.120 | 0.241 | 0.361 | 0.241 | 0.361 |
| (Surfactant) | (25 g/L) | (50 g/L) | (50 g/L) | (75 g/L) | (100 g/L) | (150 |
| | | | | | | g/L) |
| Ethanol | 8.7 | 8.7 | 23.7 | 23.7 | 8.7 | 8.7 |

TABLE 2D

| Ingredients | Comparative Examples | | | | | |
|---|---|---|---|---|---|---|
| (Name) | 17 | 18 | 19 | 20 | 21 | 22 |
| TEOS | 1 | 1 | 1 | 1 | 1 | 1 |
| H₂SO₄ 0.1M | 8 | 8 | 8 | 8 | 8 | 8 |
| Triton X-100 | 0.034 | 0.071 | 0.150 | 0.237 | 0.150 | 0.237 |
| (Surfactant) | (25 g/L) | (50 g/L) | (50 g/L) | (75 g/L) | (100 g/L) | (150 |
| | | | | | | g/L) |
| Ethanol | 8.7 | 8.7 | 25.3 | 26.2 | 8.7 | 8.7 |

TABLE 2E

Comparative Examples

| Ingredients (Name) | 23 | 24 |
|---|---|---|
| TEOS | 1 | 1 |
| H₂SO₄ 0.1M | 8 | 8 |
| Pluronic F127 (Surfactant) | 0.0018 (25 g/L) | 0.0037 (50 g/L) |
| Ethanol | 8.7 | 8.7 |

### 1.C—Preparation Process

### A. General Procedure for the Preparation of SOL 1 of Examples 1-3

### Preparation of the First Mixture:

TEOS, and the polyethylene (20) oxide hexadecyl ether were mixed in an aqueous HCl 0.1M solution in ethanol media. The resultant solution was stirred during 90 min at 60° C.

### Preparation of the Second Mixture:

Separately and simultaneously, ethanol and HCl 0.1M were mixed and stirred during 10 min at room temperature.

### Combination of the First Mixture and the Second Mixture:

Cooling the first mixture until reaching a temperature of 40° C.; and after the 10 min of stirring of second mixture, the latter was added to the first mixture; and then, the resulting mixture was stirred for 60 min and then cooled at room temperature and aged for 24 h. After that time, ethanol was added to the solution and kept stirring for 30 min to obtain SOL 1.

The amount of the TEOS, aqueous HCl 0.1M solution, ethanol and polyethylene (20) oxide hexadecyl ether used for the preparation of SOL 1 are those disclosed in the above mentioned Table 1A.

### B. General Procedure for the Preparation of SOL 2 of Example 4

### Step a) Preparation of the First Mixture

TEOS, FAS 21 and the polyethylene (20) oxide hexadecyl ether were mixed in an aqueous HCl 0.1M solution in ethanol media. The resultant solution was stirred during 90 min at 85° C.

### Step b) Preparation of the Second Mixture

Separately and simultaneously, ethanol and HCl 0.1M were mixed and stirred during 10 min at room temperature.

Steps c)-d) Combination of the First Mixture and the Second Mixture

Cooling the first mixture until reaching a temperature of 40° C.; and after the 10 min of stirring of second mixture, the latter was added to the first mixture; and then, the resulting mixture was stirred for 60 min and then cooled at room temperature and aged for 24 h. After that time, ethanol was added to the solution and kept stirring for 30 min to obtain SOL 2.

The amount of the TEOS, aqueous HCl 0.1M solution, ethanol, FAS 21 and polyethylene (20) oxide hexadecyl ether used for the preparation of SOL 2 are those disclosed in the above mentioned Table 1B.

### C. General Procedure for the Preparation of SOL 3 of Example 5

### Step a) Preparation of the First Mixture

TEOS was mixed in an aqueous HCl 0.1M solution in ethanol media. The resultant solution was stirred during 90 min at 60° C.

Step b) Preparation of the Second Mixture Separately and simultaneously, ethanol and HCl 0.1M were mixed and stirred during 10 min at room temperature.

### Steps c) and d) Combination of the First Mixture and the Second Mixture

Cooling the mixture of first mixture until reaching a temperature of 40° C.; and after the 10 min of stirring of second mixture, the latter was added to the first mixture; and then, the resulting mixture was stirred for 60 min and then cooled at room temperature and aged for 24 h to obtain SOL 3.

The amount of the TEOS, aqueous HCl 0.1M solution and ethanol used for the preparation of SOL 3 are those disclosed in the above mentioned Table 1C.

### D. General Procedure for the Preparation of Comparative SOL 1

The comparative Examples 1-24 were performed following the process as defined in general procedure A disclosed above for the preparation of SOL 1 of the present invention using the amounts and reagents as defined in the Tables 2A-2E.

### 2. Characterisation Methods

### 2.A Ellipsometry Method

Ellipsometric parameters W and A of the obtained anti-reflective system coated glasses were recorded by Variable Angle spectroscopic ellipsometer.

Spectra were recorded at wavelength comprised from 300 nm to 1000 nm at three angles of incidence (65°, 70°, 75°).

The data analysis was performed with WVase32 software.

The spectra were fitted using the dispersion Cauchy model for obtaining spectral refractive index n and film thickness. The Cauchy's equation establishes an empirical relationship between the refractive index and wavelength of light for transparent materials. Cauchy function for refractive index (n(λ)) and Cauchy function for dielectric constant (κ(λ) is calculated by the following equations:

$$\begin{matrix}n ( λ ) = A + \frac{B}{{λ}^{2}} + \frac{C}{{λ}^{4}} & Eq . 1 \\ κ ( λ ) = D + \frac{E}{{λ}^{2}} + \frac{F}{{λ}^{4}} & Eq . 2\end{matrix}$$

Analysis of ellipsometric parameters with WVase32 software provides coefficients A, B, C, D, E, F and thickness of the coatings.

The Bruggeman effective medium approximation (BEMA) model was used for obtaining void fraction. This effective medium approximation model supposes that effective medium is the same as environment, being the following equation:

$${c}_{1} \frac{{\tilde{n}}_{1}^{2} - {\tilde{n}}_{e}^{2}}{{\tilde{n}}_{1}^{2} - 2 {\tilde{n}}_{e}^{2}} + {c}_{2} \frac{{\tilde{n}}_{2}^{2} - {\tilde{n}}_{e}^{2}}{{\tilde{n}}_{2}^{2} - 2 {\tilde{n}}_{e}^{2}} = 0 \qquad Eq . 3$$

wherein: ñₑ is the complex refractive index of effective medium; ñ₁ and ñ₂ are the complex refractive indexes of 1 and 2 media; and c₁ and c₂ are the volumetric fraction of 1 and 2 media.

Analysis of ellipsometric parameters with WVase32 software provides void fraction, refractive index and thickness of the coatings. The void fraction of each coating was calculated considering polarization factor of 0.33 with respect to pure dense silica, thus value of absolute porosity in % was provided.

### Thickness

The thickness of each coating on glass as disclosed in the present invention was calculated by the ellipsometry method as defined above.

### Refractive Index Value

The value of refractive index n at a wavelength of 700 nm, n_{@700nm} of each obtained sol-gel coating on glass was calculated by the ellipsometry method as defined above.

### Absolute Porosity

The absolute porosity of each coating on glass as disclosed in the present invention was calculated by the ellipsometry method, and modelled with the Bruggeman effective medium approximation (BEMA) as defined above.

### 2.B Spectrophotometry Method

### Transmittance Spectra

Transmittance spectra of the obtained anti-reflective sol-gel coating stack on glasses were measured with a UV-Vis-NIR spectrophotometer equipped with a 150 mm integrating sphere. Spectra were taken at a wavelength comprised from 300 nm and 2000 nm with resolution of 5 nm.

### Integrated Trasmittance, τ₃₀₀₋₂₀₀₀

Integrated transmittance was calculated by weighting transmittance values with solar spectral irradiance (ASTM G173-03, pages 6-14) according to the following equation:

$$τ = \frac{{\int }_{{λ}_{1}}^{{λ}_{2}} {T}_{λ} \cdot {S}_{λ} d λ}{{\int }_{{λ}_{1}}^{{λ}_{2}} {S}_{λ} d λ} \qquad Eq . 4$$

wherein T_{λ} is the transmittance spectrum of the covered glass, S_{λ} is the hemispherical solar spectral irradiance for absolute air mass of 1.5 (ASTM G173-03, pages 6-14) and λ₁ and λ₂ define the wavelength range, in this case λ₁ is 300 nm and λ₂ is 2000 nm.
Trasmittance gain parameter, % G₃₀₀₋₂₀₀₀

Once integrated transmittance τ₃₀₀₋₂₀₀₀ values are obtained for both anti-reflective sol-gel coated glasses and bare glass (low iron soda lime silica glass), trasmittance gain parameter (G₃₀₀₋₂₀₀₀(%)) was calculated by the following Equation:

$${G}_{300 - 2000} ( \% ) = \frac{{τ}_{coated glass} - {τ}_{bare glass}}{{τ}_{bare glass}} \cdot 100 \qquad Eq . 5$$

### 2.0 Durabiliy Test

Considering a particular case of outdoor application, damp-heat accelerated aging test was performed following photovoltaics technology standards (IEC 61215 applies for components of silicon photovoltaic modules, damp heat test is explained in pages 73-75; and IEC 62108 does for components of concentrator photovoltaic modules, damp heat test is explained in pages 28-29). The obtained sol-gel anti-reflective coated glasses and bare glass were exposed for 1000 h in a climatic chamber at 85° C. and 85% RH conditions (relative humidity conditions). Transmittance spectra of samples at the beginning and at the end of the test were taken as explained above. Transmittance loss parameter (L₃₀₀₋₂₀₀₀(%)) was calculated for each anti-reflective coating stack by the following Equation:

$${L}_{300 - 2000} ( \% ) = \frac{{τ}_{initial} - {τ}_{final}}{{τ}_{final}} \cdot 100 \qquad Eq . 6$$

### 3. Anti-Reflective Sol-Gel Coated Substrates

### 3.A—Single Anti-Reflective Coating on a Substrate (MONO-LAYER)

### 3.A.1—General Procedure for the Preparation of a Single Anti-Reflective Coating on a Substrate

The process of preparing the anti-reflective mono-layer coating on a substrate is performed by depositing anti-reflective sol-gel coating composition or anti-reflective water-repellent sol-gel coating composition over a glass surface. The deposition can be performed in only one of the sides of the glass, or alternatively over both sides.

Degreasing and Cleaning of the Substrate

The degreasing and cleaning of the glass substrate to be coated was performed by immersing the glass substrate in ethanol in an ultrasonic bath.

Coating Deposition and Sintering

The degreased and cleaned glass substrate obtained in the previous step was introduced in an anti-reflective sol-gel composition (SOL 1) or alternatively in an anti-reflective water-repellent sol-gel composition (SOL 2) or in a sol-gel comparative composition (comparative SOL 1) and then it was withdrawn at a controlled rate comprised from 2 to 40 cm/min to obtain the coating. Then, coatings were thermal-sintered at a temperature comprised from 240° C. to 550° C. for a period of time comprised from 30 min to 8 h.

Optionally, the obtained coating was submitted to a post treatment with methyl-silylation solution of hexamethyldisilazane (HMDS) in n-propanol. The process for performing this additional layer is as follows:

Glass substrate coated with anti-reflective sol-gel composition (SOL 1) and sintered is immersed in a solution of 50% vol of HMDS in 1-propanol during 4 h. Then it is dried at 100° C. during 1 h.

Examples of a Single Anti-Reflective Coating on a Substrate (Mono-Layer)

Table 3 shows the experimental conditions of the process for preparing an anti-reflective coating on a substrate as defined above over a 1 mm thick soda lime glass slide substrate, and 4 mm thick low iron soda lime silica glass substrate by depositing an anti-reflective sol-gel coating composition of the invention or a comparative anti-reflective sol-gel coating composition outside the scope of the invention over one and two of the sides of the glass substrate. All the coatings in the Table 3 have been prepared by dipping method, at a withdrawal rate of 5 cm/min.

TABLE 3

| Single | | | |
|---|---|---|---|
| anti-reflective | Anti-reflective | | |
| coating on a | sol-gel coating | Sintering ^{(a)} | Post |
| substrate | compositions | Temp. (° C.) | treatment |
| M1 | Ex. 1 | 450 | — |
| M2 | Ex. 2 | 450 | — |
| M3 | Ex. 3 | 350 | — |
| M3H | Ex. 3 | 350 | HMDS |
| M4 | Ex. 3 | 450 | — |
| M5 | Ex. 3 | 550 | — |
| M5H | Ex. 3 | 550 | HMDS |
| M6 | Ex. 4 | 240 | — |
| Comp. M1 | Ex. Comp. 1 | 450 | — |
| Comp. M2 | Ex. Comp. 2 | 450 | — |
| Comp. M3 | Ex. Comp. 3 | 450 | — |
| Comp. M4 | Ex. Comp. 4 | 450 | — |
| Comp. M5 | Ex. Comp. 5 | 450 | — |
| Comp. M6 | Ex. Comp. 6 | 450 | — |
| Comp. M7 | Ex. Comp. 7 | 450 | — |
| Comp. M8 | Ex. Comp. 8 | 450 | — |
| Comp. M9 | Ex. Comp. 9 | 450 | — |
| Comp. M10 | Ex. Comp. 10 | 450 | — |
| Comp. M11 | Ex. Comp. 11 | 450 | — |
| Comp. M12 | Ex. Comp. 12 | 450 | — |
| Comp. M13 | Ex. Comp. 13 | 450 | — |
| Comp. M14 | Ex. Comp. 14 | 450 | — |
| Comp. M15 | Ex. Comp. 15 | 450 | — |
| Comp. M16 | Ex. Comp. 16 | 450 | — |
| Comp. M17 | Ex. Comp. 17 | 450 | — |
| Comp. M18 | Ex. Comp. 18 | 450 | — |
| Comp. M19 | Ex. Comp. 19 | 450 | — |
| Comp. M20 | Ex. Comp. 20 | 450 | — |
| Comp. M21 | Ex. Comp. 21 | 450 | — |
| Comp. M22 | Ex. Comp. 22 | 450 | — |
| Comp. M23 | Ex. Comp. 23 | 450 | — |
| Comp. M24 | Ex. Comp. 24 | 450 | — |

^{(a)} The time of the sintering step after each deposition step is 1 hour.

### 3.A.2—Results Corresponding to the Anti-Reflective Mono-Layer Coating on a Substrate

In the following Table 4 are included the results from the fitting of ellipsometric measurements for the mono-layer and the transmittance gain.

Particularly, the table includes the thickness expressed in nm and the reflective index value at a wavelength of 700 nm, n_{@700nm} (both calculated by Cauchy model fitting of spectral ellipsometric parameters as defined above), the absolute porosity expressed in % (by BEMA model fitting of spectral ellipsometric parameters as defined above), and the transmittance gain between 300 nm and 2000 nm (% G₃₀₀₋₂₀₀₀) of the obtained anti-reflective sol-gel coating on glasses over bare glass, expressed in %.

TABLE 4

| Single | | | | % | % |
|---|---|---|---|---|---|
| anti-reflective | Thick- | | Absolute | G₃₀₀₋₂₀₀₀ | G₃₀₀₋₂₀₀₀ |
| coating on a | ness | | porosity | One side | Two sides |
| substrate | (nm) | n_{@700 nm} | (%) | coated | coated |
| M1 | 127.2 | 1.25 | 43.3 | 2.9 | 6.2 |
| M2 | 117.8 | 1.25 | 43.5 | 3.1 | 6.2 |
| M3 | 121.3 | 1.23 | 47.9 | 3.3 | 6.7 |
| M4 | 118.4 | 1.23 | 46.6 | 2.9 | 6.2 |
| M5 | 122.3 | 1.24 | 47.5 | 2.8 | 6.1 |
| M6 | 125.7 | 1.23 | 49.0 | 3.2 | 6.3 |
| Comp. M1 | 176.1 | 1.42 | 9.7 | 0.9 | 2.0 |
| Comp. M2 | 170.8 | 1.42 | 9.7 | 0.9 | 2.1 |
| Comp. M3 | 220.0 | 1.35 | 23.1 | 1.3 | 2.8 |
| Comp. M4 | 228.1 | 1.35 | 23.1 | 1.3 | 2.7 |
| Comp. M5 | 122.6 | 1.28 | 37.7 | 2.4 | 5.7 |
| Comp. M6 | 88.6 | 1.37 | 18.3 | 1.5 | 2.6 |
| Comp. M7 | 288.1 | 1.31 | 36.6 | −1.0 | −3.1 |
| Comp. M8 | 241.3 | 1.33 | 26.6 | 1.0 | 1.4 |
| Comp. M9 | 323.6 | 1.24 | 46.8 | 2.0 | 4.2 |
| Comp. M10 | 359.7 | 1.24 | 46.9 | 1.8 | 4.1 |
| Comp. M11 | 187.0 | 1.34 | 24.9 | 1.4 | 3.0 |
| Comp. M12 | 254.1 | 1.30 | 31.7 | 2.4 | 3.4 |
| Comp. M13 | 74.0 | 1.43 | 4.3 | 0.9 | 2.1 |
| Comp. M14 | 71.0 | 1.43 | 3.4 | 0.8 | 1.9 |
| Comp. M15 | 211.0 | 1.39 | 11.9 | 0.8 | 1.5 |
| Comp. M16 | — | — | — | 0.4 | 0.3 |
| Comp. M17 | 181.5 | 1.38 | 17.7 | 1.2 | 2.3 |
| Comp. M18 | 203.3 | 1.38 | 16.4 | −0.4 | 0.4 |
| Comp. M19 | 126.9 | 1.32 | 29.0 | 2.5 | 4.5 |
| Comp. M20 | 109.6 | 1.26 | 41.9 | 1.4 | 4.8 |
| Comp. M21 | 255.3 | 1.27 | 40.8 | 1.8 | 2.1 |
| Comp. M22 | 300.8 | 1.24 | 46.0 | 1.8 | 3.9 |
| Comp. M23 | 199.8 | 1.42 | 5.5 | 0.9 | 2.0 |
| Comp. M24 | 323.1 | 1.35 | 21.4 | 1.4 | 3.4 |

The results of the above Table 4 clearly show that only the anti-reflective sol-gel coating composition of the invention allows preparing a porous anti-reflective coating on glass substrate with proper thickness and refractive index values which permits to minimise the optical reflection when light propagates across a boundary between two media with have different refractive indexes (air and glass in this case). Particularly, the anti-reflective sol-gel coating composition of the invention allows preparing a porous anti-reflective coating on glass substrates having a thickness comprised from 115 nm to 130 nm, a refractive index (at wavelength 700 nm) comprised from 1.23 to 1.25 and an absolute porosity comprised from 46.6% to 50%; which are the optimum values for preparing an anti-reflective mono-layer coating. Therefore, the sol-gel coating composition of the invention allows obtaining highest transmittance gain over bare glass, being greater than 6.1% for sol-gel anti-reflective coatings deposited onto two sides of glass and greater than 2.8% for sol-gel anti-reflective coatings deposited onto one side of glass.

### 3.B— Anti-Reflective Multi-Layer Stack on a Substrate

### 3.B.1—General Procedure for the Preparation of an Anti-Reflective Bi-Layer Stack on a Substrate

The process of depositing the anti-reflective sol-gel coating composition over a glass surface can be performed in only one of the sides of the glass, or alternatively over both sides.

Degreasing and Cleaning of the Substrate

The degreasing and cleaning of the glass substrate to be coated was performed by immersing the glass substrate in ethanol in an ultrasonic bath.

Coating Deposition and Sintering

The degreased and cleaned glass substrate obtained in the previous step was first introduced in a sol-gel composition SOL 3 and then it was withdrawn at a controlled rate comprised from 2 cm/min to 40 cm/min to obtain the coating. Then coating was thermal-sintered at a temperature comprised from 350° C. to 550° C. for a period of time comprised from 30 min to 8 h, or alternatively dried at a temperature of 200° C. for a period of time of 1 h.

Then, the coated glass substrate obtained above was secondly introduced in an anti-reflective sol-gel composition (SOL 1) or alternatively in an anti-reflective water-repellent sol-gel composition (SOL 2) and then it was withdrawn at a controlled rate comprised from 2 cm/min to 40 cm/min to obtain the bi-layer. Then, the coatings were thermal-sintered at a temperature comprised from 240° C. to 700° C. for a period of time comprised from 5 min to 8 h.

Optionally, the obtained multi-layer is submitted to post treatment with methyl-silylation solution of hexamethyldisilazane (HMDS)/1-propanol. The process for performing this additional layer is as defined in previous section.

Examples of Anti-Reflective Multi-Layer (Bi-Layer) Stacks

Table 5A shows the experimental conditions of the process for preparing an anti-reflective bi-layer stack over a 4 mm thick low iron soda lime silica glass by depositing first a sol-gel coating composition SOL 3 followed by a sintering step; and further followed by depositing a sol-gel anti-reflective coating composition SOL 1, or alternatively anti-reflective water-repellent sol-gel coating composition SOL 2, followed by a sintering step. All the anti-reflective coating stacks in Table 5A have been prepared by dipping method, at a withdrawal rate of 5 cm/min.

TABLE 5A

| | INNER SOL-GEL | | EXTERNAL SOL-GEL | | |
|---|---|---|---|---|---|
| | COATING LAYER | | COATING LAYER | | |
| Anti-re- | Sol-gel | Sin- | Sol-gel | Sin- | |
| flective | coating | tering ^{(a)} | coating | tering ^{(a)} | |
| bi-layer | composi- | Temp. | composi- | Temp. | Post |
| stacks | tion | (° C.) | tion | (° C.) | treatment |
| B3 | SOL 3 Ex. 5 | 350 | SOL 1 Ex. 3 | 350 | — |
| B3H | SOL 3 Ex. 5 | 350 | SOL 1 Ex. 3 | 350 | HMDS |
| B5 | SOL 3 Ex. 5 | 550 | SOL 1 Ex. 3 | 550 | — |
| B5H | SOL 3 Ex. 5 | 550 | SOL 1 Ex. 3 | 550 | HMDS |
| B6 | SOL 3 Ex. 5 | 550 | SOL 2 Ex. 4 | 240 | — |

^{(a)} The time of the sintering step after each deposition step is 1 hour.

Table 5B shows the experimental conditions of the process for preparing an anti-reflective bi-layer stack over a 4 mm thick low iron soda lime silica glass by depositing first a sol-gel coating composition SOL 3 followed by a drying step; and further followed by depositing a sol-gel anti-reflective coating composition SOL 1, or alternatively anti-reflective water-repellent sol-gel coating composition SOL 2, followed by a sintering step. All the anti-reflective coating stacks in Table 5B have been prepared by dipping method, at a withdrawal rate of 5 cm/min.

TABLE 5B

| | INNER SOL-GEL | | EXTERNAL SOL-GEL | | |
|---|---|---|---|---|---|
| | COATING LAYER | | COATING LAYER | | |
| Anti-re- | | Drying | | Sintering | |
| flective | Sol-gel | Temp. | Sol-gel | Temp. | |
| bi-layer | coating | (° C.)/time | coating | (° C.)/time | Post |
| stacks | composition | (min) | composition | (min) | treatment |
| B7 | SOL 3 Ex. 5 | 200/60 | SOL 1 Ex. 3 | 550/60 | — |
| B8 | SOL 3 Ex. 5 | 200/60 | SOL 1 Ex. 3 | 700/5 | — |

### 3.B.2—Results Corresponding to the Anti-Reflective Bi-Layer Stack on a Substrate

In the following Table 6 is included the results from the fitting of ellipsometric measurements for each sol-gel coating composing the bi-layer stacks.

Particularly, the Tables includes the thickness expressed in nm and the reflective index value at a wavelength of 700 nm, n_{@700nm} (calculated by Cauchy model fitting of spectral ellipsometric parameters as defined above); absolute porosity expressed in % (obtained by BEMA model fitting of spectral ellipsometric parameters as defined above).

TABLE 6

| | | | EXTERNAL SOL-GEL | | |
|---|---|---|---|---|---|
| Anti- | INNER SOL-GEL | | COATING LAYER | | |
| reflective | COATING LAYER | | | | Absolute |
| bi-layer | Thickness | | Thickness | | porosity |
| stack | (nm) | n_{@700 nm} | (nm) | n_{@700 nm} | (%) |
| B3 | 141.0 | 1.42 | 103.7 | 1.22 | 49.7 |
| B5 | 117.3 | 1.46 | 134.1 | 1.20 | 54.9 |
| B6 | 96.1 | 1.47 | 125.1 | 1.23 | 47.7 |
| B7 | 101.7 | 1.47 | 116.9 | 1.26 | 42.4 |
| B8 | 107.0 | 1.48 | 127.4 | 1.24 | 47.3 |

In the Table 7 is shown the transmittance gain between 300 nm and 2000 nm (% G₃₀₀₋₂₀₀₀) of the obtained anti-reflective stack on glasses over bare glass, expressed in %.

TABLE 7

| | % G₃₀₀₋₂₀₀₀ One | % G₃₀₀₋₂₀₀₀ Two |
|---|---|---|
| Bi-layer Stack | side coated | sides coated |
| B3 | 2.6 | 6.9 |
| B5 | 3.0 | 7.0 |
| B6 | 3.0 | 6.9 |
| B7 | — | 7.5 |
| B8 | — | 7.3 |

The results of the above Table 6 clearly show that the bi-layer formed by inner sol-gel coating composition and external anti-reflective sol-gel coating composition of the invention allows preparing an anti-reflective multi-layer (bi-layer) stack on glass substrate with proper thickness and refractive index values which permits to minimise the optical reflection when light propagates across a boundary between two media with have different refractive indexes (air and glass in this case). Particularly, the combination of these two layers permits to prepare anti-reflective multi-layer stack on a substrate wherein the inner layer of the stack has a thickness comprised from 95 nm to 141 nm, refractive index (at wavelength 700 nm) comprised from 1.42 to 1.48, and the external layer of the stack has a thickness comprised from 103 and 135 nm, refractive index (at wavelength 700/632.8 nm) comprised from 1.20 to 1.26 and an absolute porosity comprised from 42.4% to 54.9%.

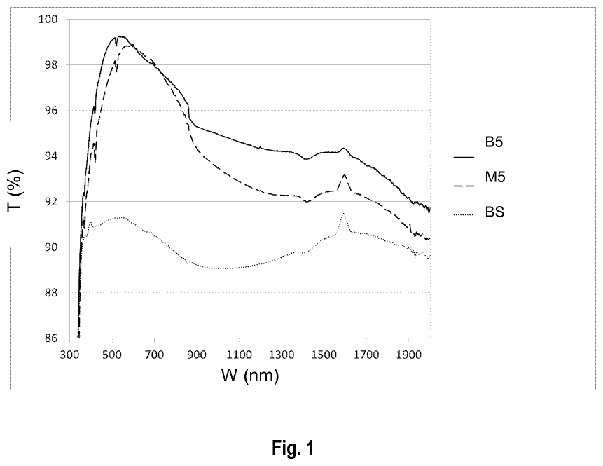

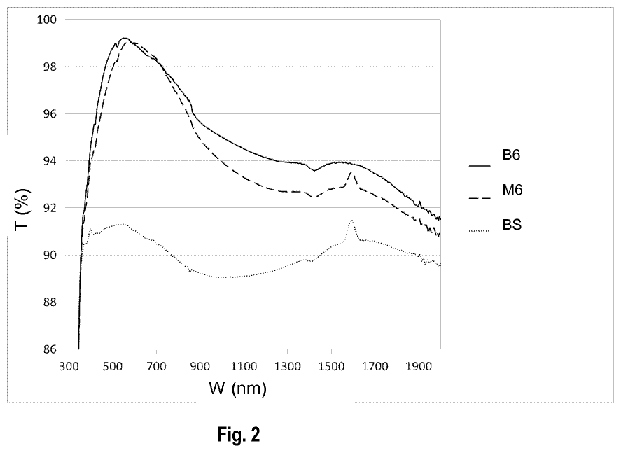

Indeed, the results of the above Table 7 show that transmittance gain of the anti-reflective bi-layer stacks is slightly superior over the single anti-reflective coating of the present invention. Therefore, the anti-reflective bi-layer stacks deposited with the sol-gel coating compositions of the invention allows obtaining highest transmittance gain over bare glass, being greater than 6.9% for the bi-layer stack deposited onto two sides of glass. Furthermore, as it can be seen in FIG. 1 and FIG. 2, the single anti-reflective (mono-layer) coating and the anti-reflective multi-layer (bi-layer) stacks of the invention provide a transmittance increase in the whole spectral range with respect to the bare substrate, and the anti-reflective multi-layer (bi-layer) stacks provide higher transmittance even than single anti-reflective (mono-layer) coating. Therefore, anti-reflective multi-layer (bi-layer) stacks present superior broadband anti-reflective properties. That means that anti-reflective multi-layer (bi-layer) stack allows to minimise the optical reflection when light propagates across a boundary between two media with have different refractive indexes (air and glass in this case) in a wider wavelength range comprised in solar spectrum.

### 4. Water-Repellence of Sol-Gel Anti-Reflective Coating on Substrates or Anti-Reflective Multi-Layer Stacks on Substrates with or without Hexamethyldisilazane Post Treatment

Tables 8 and 9 show water contact angle measured onto the surface of the deposited anti-reflective sol-gel coating composition; or the deposited anti-reflective sol-gel coating composition post treated with HMDS solution as explained above (H), or the deposited anti-reflective water-repellent sol-gel coating composition both in mono-layer and in bi-layer stacks. All the coatings have been prepared over 4 mm thick extra clear glass substrate by dipping method, at a withdrawal rate of 5 cm/min.

Table 8 contains the results concerning single anti-reflective coating (mono-layer), and Table 9 contains the results concerning the anti-reflective multi-layer (bi-layer) stacks.

TABLE 9

| Anti-reflective multi-layer (bi-layer) stacks | Water Contact Angle (°) |
|---|---|
| B3 | 20.6 ± 1.7 |
| B3H | 96.7 ± 1.2 |
| B5 | 34.5 ± 0.9 |
| B5H | 95.4 ± 1.6 |
| B6 | 93.4 ± 1.2 |

TABLE 8

| Anti-reflective coating (mono-layer) | Water Contact Angle (°) |
|---|---|
| M3 | 16.6 ± 1.1 |
| M3H | 94.4 ± 1.2 |
| M5 | 19.5 ± 1.4 |
| M5H | 91.1 ± 2.1 |
| M6 | 102.2 ± 1.7 |

Tables 10 and 11 show the transmittance gain between 300 nm and 2000 nm (% G₃₀₀₋₂₀₀₀) of the obtained anti-reflective coating (mono-layer) and anti-reflective bi-layer stacks on glasses over bare glass post-treated with HMDS solution, expressed in %.

Table 10 contains the results concerning anti-reflective coating (mono-layer) and Table 11 contains the results concerning anti-reflective multi-layer (bi-layer) stacks.

TABLE 10

| | % G₃₀₀₋₂₀₀₀ | % G₃₀₀₋₂₀₀₀ |
|---|---|---|
| Mono-layer stack coated | One side coated | Two sides coated |
| M3H | 2.7 | 6.2 |
| M5H | 2.5 | 5.8 |

TABLE 11

| | % G₃₀₀₋₂₀₀₀ | % G₃₀₀₋₂₀₀₀ |
|---|---|---|
| Bi-layer stack coated | One side coated | Two sides coated |
| B3H | — | 6.2 |
| B5H | 2.8 | 6.7 |

The results of the above Table 8 and Table 9 clearly show that hydrophobic surfaces repelling water with water contact angles higher than 90° can be obtained both by anti-reflective sol-gel coating compositions post-treated with HMDS solution, and by anti-reflective water-repellent sol-gel coating compositions without post-treatment with HMDS. However, it is important to note that anti-reflective sol-gel coating is deposited in a single step, which is advantageous from the point of view of the industrial process.

The results of the above Table 10 and Table 11 show that transmittance gain of the non-post-treated anti-reflective sol-gel are slightly higher than the anti-reflective sol-gel post-treated coatings.

### 5. Durability Test Results

Table 12 shows the transmittance loss in the wavelength range comprised from 300 nm to 2000 nm (% L₃₀₀₋₂₀₀₀) between initial values and values after 1000 h of exposure to durability test of the anti-reflective coating (mono-layer) on a substrate and the anti-reflective multi-layer (bi-layer) stack on a substrate; or of the anti-reflective coating (mono-layer) and anti-reflective multi-layer (bi-layer) stacks post-treated with HMDS solution as explained above (H); or anti-reflective water-repellent coating (mono-layer) and anti-reflective water-repellent multi-layer (bi-layer) stacks on a substrate. All the coatings and stacks on the substrates have been prepared over 4 mm thick low iron soda lime silica glass substrate by dipping method, at a withdrawal rate of 5 cm/min.

Table 12 contains the results concerning the anti-reflective coatings (mono-layer), and the anti-reflective bi-layer stacks.

TABLE 12

| | % L₃₀₀₋₂₀₀₀ |
|---|---|
| Anti-reflective system | after Damp Heat Test |
| M5H | 1.6 |
| B3 | 0.8 |
| B3H | 0.1 |
| B5 | 0.1 |
| B5H | 0 |
| B6 | 0.1 |

The results of the above Table 12 show that transmittance loss along the durability test is very low and acceptable.

### 6. Conclusion

The above mentioned results clearly show that the anti-reflective sol-gel coating compositions of the present invention permit to obtain single anti-reflective coating and anti-reflective multi-layer stacks that provide enhanced anti-reflective properties over a broad wavelength region with regard to sol-gel coatings of the state of the art. Furthermore, anti-reflective and water-repellent sol-gel coatings of the present invention permit to obtain hydrophobic surfaces without detrimental effects on optical performance in a single step.

Functionalisation post-treatments in controlled conditions can further be applied on the anti-reflective systems of the present invention. Anti-reflective systems composed by single coating or multiple layer stack of the present invention on a substrate, show a good performance regarding durability properties, particularly the anti-reflective (bi-layer) stack of the present invention.

The results of the Tables above clearly show that the single sol-gel anti-reflective coating on glass substrate and the sol-gel anti-reflective multi-layer stack on a substrate of the present invention have a higher durability than the sol-gel of the state of the art, particularly the anti-reflective (bi-layer) stack of the present invention.

The above mentioned results clearly show that in comparison with the sol-gel coatings disclosed in the state of the art, the sol-gel coating compositions of the present invention allows preparing a sol-gel coating and stacks having exceptional broad band anti-reflective properties and having also a good performance regarding durability properties.

### 7. Comparative Composition

### 7.1 Composition of the Comparative Sol-Gel Coating Compositions

Table 13 show the quantitative components intervening in the preparation of the comparative sol-gel coating compositions outside the scope of the present invention, where the amount of the ingredients is expressed in molar ratio.

TABLE 13

| Ingredients | | Comparative Examples | | | |
|---|---|---|---|---|---|
| Function | Name | 25 | 26 | 27^{(a)} | 28^{(a)} |
| Hydrolysable | TEOS | 1 | 1 | 1 | 1 |
| siliconal koxide | | | | | |
| An aqueous | HCl 0.1M | 2.7 | 8 | 8 | 8 |
| solution of at least | | | | | |
| an acid catalyst | | | | | |
| Surfactant | polyethylene | 0.1233 (77.6 g/L) | 0.1233 (77.6 g/L) | 0.1233 (77.6 g/L) | 0.1233 (77.6 g/L) |
| | (20) oxide | | | | |
| | hexadecyl | | | | |
| | ether (Brij58) | | | | |
| (C₁-C₈)alcohol | ethanol | 6.1 | 12.2 | 24.4 | 24.4 |

^{(a)}the processes for the preparation of the comparative sol-gel coating compositions of comparative examples 27 and 28 are different.

### 7.2 Preparation Process

### A. Procedure for the Preparation of the Comparative Sol-Gel Coating Compositions of Comparative Example 25

The process for the preparation of the comparative Example 25 involves preparing a unique SOL having the molar ratio of the components disclosed in Table 13, which corresponds to perform step (a) of the process of the invention. Thus, this process does not involve performing steps (b), (c) and (d).

TEOS and the polyethylene (20) oxide hexadecyl ether were mixed in an aqueous HCl 0.1M solution in ethanol media. The resultant solution was stirred during 90 min at 60° C. After that time the sol is cooled at room temperature and aged for 24 h. The molar ratio of TEOS, aqueous HCl 0.1M solution, ethanol and polyethylene (20) oxide hexadecyl ether used is 1:2.7:6.1:0.1233 as disclosed in the Table 13.

### B. Procedure for the Preparation of the Comparative Sol-Gel Coating Compositions of Comparative Example 26

The process for the preparation of the comparative Example 26 involves preparing a unique SOL having the molar ratio of the components disclosed in Table 13 by mixing the amount of ethanol corresponding to the sum of the amount of ethanol used in step (a) and (b) in a single addition; and also the amount of the acid catalyst corresponding to the sum of the amount of the acid catalyst used in step (a) and (b) in a single addition. Thus, this process does not involve performing steps (b), (c) and (d).

TEOS and the polyethylene (20) oxide hexadecyl ether were mixed in an aqueous HCl 0.1M solution in ethanol media. The resultant solution was stirred during 90 min at 60° C. After that time the sol is cooled at room temperature and aged for 24 h. The molar ratio of TEOS, aqueous HCl 0.1M solution, ethanol and polyethylene (20) oxide hexadecyl ether used is 1:8:12.2:0.1233 as disclosed in the Table 13.

### C. Procedure for the Preparation of the Comparative Sol-Gel Coating Compositions of Comparative Example 27

The process for the preparation of the comparative Example 27 involves preparing a SOL 1 according to step (a) of the present invention, and then adding directly to the SOL1 the amount of ethanol and acid catalyst used in step (b) of the process of the present invention without the preparation of the second mixture (SOL2). Thus, this process does not involve performing steps (b), (c) and (d).

TEOS, and the polyethylene (20) oxide hexadecyl ether were mixed in an aqueous HCl 0.1M solution in ethanol media. The resultant solution was stirred during 90 min at 60° C. After that time sol is cooled at room temperature and aged for 24 h to obtain SOL1. The molar ratio of TEOS, aqueous HCl 0.1M solution, ethanol and polyethylene (20) oxide hexadecyl ether used for the preparation of the SOL1 is 1:8:12.2:0.1233.

Then, ethanol was added to the solution and kept stirring for 30 min to obtain SOL 1. The amount of the TEOS, aqueous HCl 0.1M solution, ethanol and polyethylene (20) oxide hexadecyl ether used for the preparation of the final SOL is 1:8:24.4:0.1233 as disclosed in the Table 13.

### C. Procedure for the Preparation of the Comparative Sol-Gel Coating Compositions of Comparative Example 28

The process for the preparation of the comparative Example 28 involves preparing a unique SOL having the molar ratio of the components disclosed in Table 13 by mixing the amount of ethanol corresponding to the sum of ethanol used in steps (a), (b), and (d) in a single addition and also by mixing the amount of acid catalyst corresponding to the sum of acid catalyst used in steps (a) and (b) in a single addition. Thus, this process does not involve performing steps (b), (c) and (d).

TEOS, and the polyethylene (20) oxide hexadecyl ether were mixed in an aqueous HCl 0.1M solution in ethanol media. The resultant solution was stirred during 90 min at 60° C. After that time the sol is cooled at room temperature and aged for 24 h. The molar ratio of TEOS, aqueous HCl 0.1M solution, ethanol and polyethylene (20) oxide hexadecyl ether used is 1:8:24.4:0.1233 as disclosed in the Table 13.

### 7.3—Single Anti-Reflective Coating on a Substrate (MONO-LAYER)

The process of preparing the anti-reflective mono-layer coating on a substrate is performed by depositing the comparative anti-reflective sol-gel coating compositions 25-28 over a glass surface. The deposition is performed over one and two of the sides of the glass substrate

The process for the preparation of the single anti-reflective coating on a substrate is the process as disclosed in section 3.A.1 of the present invention but using the comparative sol-gel coating compositions 25-28 as defined in previous section.

Table 14 shows the experimental conditions of the process for preparing of an anti-reflective coating (M1-M6) or an comparative anti-reflective coating (M25-M29) on a substrate as defined above over a 4 mm thick low iron soda lime silica glass substrate by depositing a comparative anti-reflective sol-gel coating composition outside the scope of the invention over one and two of the sides of the glass substrate. All the coatings in the Table 14 have been prepared by dipping method, at a withdrawal rate of 5 cm/min.

TABLE 14

| Single | | |
|---|---|---|
| anti-reflective | Anti-reflective | |
| coating on a | sol-gel coating | Sintering ^{(a)} |
| substrate | compositions | Temp. (° C.) |
| M1 | Ex. 1 | 450 |
| M2 | Ex. 2 | 450 |
| M3 | Ex. 3 | 350 |
| M4 | Ex. 3 | 450 |
| M5 | Ex. 3 | 550 |
| M6 | Ex. 4 | 240 |
| Comp. Ex. M25 | Ex. Comp. 25 | 550 |
| Comp. Ex. M26 | Ex. Comp. 26 | 550 |
| Comp, Ex. M27 | Ex. Comp. 27 | 550 |
| Comp. Ex. M28 | Ex. Comp. 28 | 550 |

^{(a)} the time of the sintering step after each deposition step is 1 hour

### 7.4—Results Corresponding to the Anti-Reflective Mono-Layer Coating on a Substrate

In the following Table 15 are included the results from the fitting of ellipsometric measurements for the mono-layer and the transmittance gain.

Particularly, the table includes the thickness expressed in nm and the reflective index value at a wavelength of 700 nm, n_{@700nm} (both calculated by Cauchy model fitting of spectral ellipsometric parameters as defined above), the absolute porosity expressed in % (by BEMA model fitting of spectral ellipsometric parameters as defined above), and the transmittance gain between 300 nm and 2000 nm (% G₃₀₀₋₂₀₀₀) of the obtained anti-reflective sol-gel coating on glasses over bare glass, expressed in %.

TABLE 15

| Single | | | | % | % |
|---|---|---|---|---|---|
| anti-reflective | Thick- | | Absolute | G₃₀₀₋₂₀₀₀ | G₃₀₀₋₂₀₀₀ |
| coating on a | ness | | porosity | One side | Two sides |
| substrate | (nm) | n_{@700 nm} | (%) | coated | coated |
| M1 | 127.2 | 1.25 | 43.3 | 2.9 | 6.2 |
| M2 | 117.8 | 1.25 | 43.5 | 3.1 | 6.2 |
| M3 | 121.3 | 1.23 | 47.9 | 3.3 | 6.7 |
| M4 | 118.4 | 1.23 | 46.6 | 2.9 | 6.2 |
| M5 | 122.3 | 1.24 | 47.5 | 2.8 | 6.1 |
| M6 | 125.7 | 1.23 | 49.0 | 3.2 | 6.3 |
| Comp. | 398.9 | 1.26 | 40.41 | 2.3 | 4.2 |
| Ex. M25 | | | | | |
| Comp. | 190.2 | 1.32 | 27.8 | 2.5 | 4.8 |
| Ex. M26 | | | | | |
| Comp. | 110.0 | 1.29 | 35.6 | 2.3 | 4.6 |
| Ex. M27 | | | | | |
| Comp. | 107.8 | 1.30 | 33.2 | 2.6 | 3.9 |
| Ex. M28 | | | | | |

The results of the above Table 15 clearly show that the process for the preparing of the anti-reflective sol-gel coating composition of the invention allows obtaining a porous anti-reflective coating on glass substrates having a thickness comprised from 115 nm to 130 nm and a highest transmittance gain over bare glass, being greater than 6.1% for sol-gel anti-reflective coatings deposited onto two sides of glass and greater than 2.8% for sol-gel anti-reflective coatings deposited onto one side of glass. In comparison, the comparative sol-gel coating compositions, which has been prepared by a process not having steps (a)-(d), do not allow preparing porous anti-reflective coating on glass substrates having a thickness comprised from 115 nm to 130 nm and a transmittance gain over bare glass greater than 6.1% for two sides deposition and greater than 2.8% for deposition onto one side of the glass.

Furthermore, comparative single anti-reflective coating on a substrate of comparative Example M28 does not show homogeneity on the surface, since it exhibited defects such as craters and holes appreciated with naked eye.

### REFERENCES CITED IN THE APPLICATION

1. ASTM C1048. Standard specification for heat-strengthened and fully tempered flat glass
2. EN 12150. Glass in building—Thermally toughened soda lime silicate safety glass
3. ASTM G173-03. Standard tables for reference solar spectral irradiances: direct normal and hemispherical on 37° tilted surface, pp. 6-14.
4. IEC 61215:2005. Crystalline silicon terrestrial photovoltaic (PV) modules—Design, qualification and type approval, pp. 73-75
5. IEC 62108:2016. Concentrator photovoltaic (CPV) modules and assemblies—Design, qualification and type approval, pp. 28-29

1. A process for preparing an anti-reflective sol-gel coating composition comprising:
a) first mixing a hydrolysable silicon alkoxide, one or more (C₁-C₈)alcohols, an aqueous solution of at least one acid catalyst; and one or more surfactants of formula (II):
HO(CH₂CH₂O)ₘR⁹ (II)
then maintaining the resulting mixture at a temperature comprised from 50° C. to 120° C. for an appropriate period of time; and finally cooling the mixture until reaching a temperature comprised from 30° C. to 50° C., wherein:
R⁹ is (C₁-C₃₀)alkyl, and m is an integer selected from 2 to 40; the concentration of the surfactant of formula (II) in the resulting first mixture is comprised from 150 g/L to 300 g/L;
the molar ratio between the hydrolysable silicon alkoxide and the aqueous solution of acid catalyst is comprised from 0.15 to 1; and the molar ratio between the hydrolysable silicon alkoxide and the (C₁-C₈)alcohol is comprised from 0.15 to 0.30, and the molar ratio between the hydrolysable silicon alkoxide and the surfactant of formula (II) is comprised from 7 to 11.5;
b) preparing a second mixture by mixing one or more (C₁-C₈)alcohols, and an aqueous solution of at least one acid catalyst; and maintaining the resulting mixture at a temperature comprised from 15° C. to 30° C.;
c) adding the second mixture obtained in step b) to the resulting mixture of step a); and maintaining the resulting mixture at a temperature comprised from 30° C. to 50° C. for an appropriate period of time; and
d) cooling the resulting mixture obtained in step c) until reaching a temperature comprised from 15° C. to 30° C.; and adding one or more (C₁-C₈)alcohols until the molar ratio between the hydrolysable silicon alkoxide and the (C₁-C₈)alcohol in the anti-reflective sol-gel coating composition is comprised from 0.025 to 0.100
wherein:
the concentration of the surfactant of formula (II) in the anti-reflective sol-gel coating composition is comprised from 55 g/L to 90 g/L, the molar ratio between the hydrolysable silicon alkoxide and the aqueous solution of at least one acid catalyst is comprised from 0.050 to 0.350, and the molar ratio between the hydrolysable silicon alkoxide and the surfactant of formula (II) is comprised from 7 to 11.5.

2. The process according to claim 1, wherein the surfactant of formula (II) is polyethylene (20) oxide hexadecyl ether.

3. The process according to claim 1, wherein the hydrolysable silicon alkoxide is selected from the group consisting of:
i) a totally hydrolysable silicon alkoxide of formula (IA)
Si(OR¹)(OR²)(OR³)(OR⁴) (IA)
ii) an alkylalkoxide having at least one non-hydrolysable substituent being the non-hydrolysable substituent a substituted or un-substituted (C₁-C₄)alkyl of formula (IB)
R⁸—Si(OR⁵)(OR⁸)(OR⁷) (IB)
and iii) a mixture of at least a totally hydrolysable silicon alkoxide of formula (IA) and at least an alkylalkoxide having at least one non-hydrolysable substituent being the non-hydrolysable substituent a substituted or un-substituted (C₁-C₄)alkyl of formula (IB); wherein: each one of R¹, R², R³, R⁴, R⁵, R⁶ and R⁷ are independently selected from the group consisting of a substituted or un-substituted (C₁-C₁₄)alkyl, (C₅-C₆)aryl, (C₂-C₁₄)alkenyl and (C₂-C₁₄)alkynyl group; and R⁸ is a substituted or un-substituted (C₁-C₄)alkyl.

4. The process according to claim 1, wherein the aqueous solution of the at least one acid catalyst is an aqueous solution of an inorganic acid selected from the group consisting of H₂SO₄, HCl, HNO₃, and mixtures thereof having a pH lower than 5.

5. The process according to claim 1, wherein the (C₁-C₈)alcohol is selected from the group consisting of ethanol, butanol, propanol, and mixtures thereof.

6. The process according to claim 1, wherein the molar ratio between the hydrolysable silicon alkoxide, the aqueous solution of at least one acid catalyst, the (C₁-C₈)alcohol and the surfactant of formula (II) in the resulting mixture of step a) is 1:8:24.4:0.12.

7. The process according to claim 1, wherein the process for preparing the anti-reflective sol-gel coating composition further comprises adding a silicon precursor having at least one non-hydrolysable substituent bonded to the silicon atom to the initial mixture of step a).

8. The process according to claim 7, wherein the silicon precursor having at least one non-hydrolysable substituent bonded to the silicon atom is a compound of formula (III):
[CF₃(CF₂)ₙ(CH₂)ₘ]—Si(OR¹⁰)_{b} (III)
wherein each R¹⁰ is independently selected from the group consisting of (C₁-C₂₀)alkyl, (C₂-C₂₀)alkenyl and (C₂-C₂₀)alkyl-CH═CH—; m and n are independently an integer comprised from 0 to 20, a is an integer selected from 1, 2 and 3; b is an integer selected from 1, 2, and 3; the sum of a+b is 4; or alternatively a compound of formula (IV):
[CF₃—(CF₂)ₙ(CH₂)ₘ]ₐ—SiX_{b} (IV)
wherein each X is an halogen independently selected from the group consisting of chlorine, bromine and iodine; m and n are independently an integer comprised from 0 to 20, a is an integer selected from 1, 2 and 3; b is an integer selected from 1, 2, and 3; the sum of a+b is 4; or alternatively
a compound of formula (V)
(R¹¹)ₐSi(OR¹²)_{b} (V)
wherein each R¹¹ and each R¹² is independently selected from the group consisting of (C₁-C₂₀)alkyl, (C₂-C₂₀)alkenyl and (C₂-C₂₀)alkyl-CH═CH—; a is an integer selected from 1, 2 and 3; b is an integer selected from 1, 2, and 3; the sum of a+b is 4; or alternatively
a compound of formula (VI)
[CH₃—(CH₂)ₘ]ₐ—SiX_{b} (VI)
wherein each X is an halogen independently selected from the group consisting of chlorine, bromine and iodine; m is an integer comprised from 0 to 20, a is an integer selected from 1, 2 and 3; b is an integer selected from 1, 2, and 3; the sum of a+b is 4.

9. An anti-reflective sol-gel coating composition obtainable by the process as defined in claim 1.

10. An anti-reflective water-repellent sol-gel coating composition obtainable by the process as defined in claim 7.

11. A process for preparing a single anti-reflective coating on a substrate which comprises:
e) depositing a mono-layer of the anti-reflective sol-gel coating composition as defined in claim 9 over the substrate; and
f) sintering the coating obtained in step e); and optionally
the process further comprises additional step i) after step f); or alternatively
the process further comprises additional step ii) after step f); or alternatively
the process further comprises additional step i) after step f) followed by step ii); or
alternatively
the process further comprises additional step ii) after step f) followed by step i);
wherein:
step i) comprises depositing one or more additional coating over the external coating of the substrate; and
step ii) comprises surface functionalization of the external coating of the substrate.

12. A process for preparing an anti-reflective multilayer stack on a substrate which comprises:
g) firstly, depositing a first inner layer over the substrate by a process which comprises:
g1) providing a sol-gel coating composition obtainable by a process which comprises:
g1a) first mixing an hydrolysable silicon alkoxide, one or more (C₁-C₈)alcohols, and an aqueous solution of at least one acid catalyst; and then maintaining the resulting mixture at a temperature comprised from 50° C. to 70° C. for an appropriate period of time; and finally cooling the mixture until reaching a temperature comprised from 30° C. to 50° C.
g1 b) preparing a second mixture by mixing one or more (C₁-C₈)alcohols, and an aqueous solution of at least one acid catalyst; and maintaining the resulting mixture at a temperature comprised from 15° C. to 30° C. for an appropriate period of time;
g1c) adding the second mixture obtained in step g1 b) to the resulting mixture of step g1a); and maintaining the resulting mixture at a temperature comprised from 30° C. to 50° C. for an appropriate period of time;
g2) depositing the sol-gel coating composition over the substrate; and
g3) drying or sintering the coating obtained in step g2); and
h) secondly, depositing an external anti-reflective layer over the inner layer on the substrate, by a process which comprises:
h1) depositing the anti-reflective sol-gel coating composition as defined in claim 9 over the inner layer on the substrate;
h2) sintering the coating obtained in step h1); and optionally;
the process further comprises an additional step i) after step h); or alternatively
the process further comprises additional step ii) after step h); or alternatively
the process further comprises additional step i) after step h) followed by step ii); or
alternatively
the process further comprises additional step ii) after step h) followed by step i); wherein:
step i) comprises depositing one or more additional coating over the external coating of the substrate; and
step ii) comprises surface functionalization of the external coating of the substrate.

13. The process according to claim 11, wherein the depositing steps are performed by dipping the substrate in the coating composition at a deposition rate comprised from 2 cm/min to 40 cm/min; and the sintering steps are performed at a temperature comprised from 200° C. to 700° C. for an appropriate period of time.

14. A single anti-reflective coating on a substrate or an anti-reflective multilayer stack on a substrate obtainable by the process as defined in claim 11.

15. A single anti-reflective coating on a substrate or an anti-reflective multilayer stack on a substrate obtainable by the process as defined in claim 11, wherein the mono-layer coating has a thickness comprised from 100 nm to 140 nm and a refractive index comprised from 1.20 to 1.26 at a wavelength of 700 nm which is obtainable by the process as defined in claim 11 wherein the hydrolysable silicon alkoxide is tetraethylorthosilicate (TEOS), the (C₁-C₈)alcohol is ethanol, the acid catalyst is an aqueous acidic solution of HCl, and the surfactant of formula (II) is polyethylene (20) oxide hexadecyl ether.

16. The process according to claim 2, wherein the hydrolysable silicon alkoxide is selected from the group consisting of:
i) a totally hydrolysable silicon alkoxide of formula (IA)
Si(OR¹)(OR²)(OR³)(OR⁴) (IA)
ii) an alkylalkoxide having at least one non-hydrolysable substituent being the non-hydrolysable substituent a substituted or un-substituted (C₁-C₄)alkyl of formula (IB)
R⁸—Si(OR⁵)(OR⁸)(OR⁷) (IB)
and iii) a mixture of at least a totally hydrolysable silicon alkoxide of formula (IA) and at least an alkylalkoxide having at least one non-hydrolysable substituent being the non-hydrolysable substituent a substituted or un-substituted (C₁-C₄)alkyl of formula (IB); wherein: each one of R¹, R², R³, R⁴, R⁵, R⁶ and R⁷ are independently selected from the group consisting of a substituted or un-substituted (C₁-C₁₄)alkyl, (C₅-C₆)aryl, (C₂-C₁₄)alkenyl and (C₂-C₁₄)alkynyl group; and R⁸ is a substituted or un-substituted (C₁-C₄)alkyl.

17. An anti-reflective water-repellent sol-gel coating composition obtainable by the process as defined in claim 8.

18. A process for preparing a single anti-reflective coating on a substrate which comprises:
e) depositing the anti-reflective water-repellent sol-gel coating composition as defined in claim 17 over the substrate; and
f) sintering the coating obtained in step e); and optionally
the process further comprises additional step i) after step f); or alternatively
the process further comprises additional step ii) after step f); or alternatively
the process further comprises additional step i) after step f) followed by step ii); or
alternatively
the process further comprises additional step ii) after step f) followed by step i);
wherein:
step i) comprises depositing one or more additional coating over the external coating of the substrate; and
step ii) comprises surface functionalization of the external coating of the substrate.

19. A single anti-reflective coating on a substrate or an anti-reflective multilayer stack on a substrate obtainable by the process as defined in claim 12.

20. A single anti-reflective coating on a substrate or an anti-reflective multilayer stack on a substrate obtainable by the process as defined in claim 12, which is an anti-reflective bi-layer stack wherein the external layer of the stack has a thickness comprised from 100 nm to 140 nm and a refractive index comprised from 1.20 to 1.26 at a wavelength of 700 nm; and the inner layer of the stack has a thickness comprised from 95 nm to 150 nm and a refractive index comprised from 1.42 to 1.48 at a wavelength of 700 nm, which is obtainable by the process as defined in claim 12, wherein the hydrolysable silicon alkoxide is tetraethylorthosilicate (TEOS), the (C₁-C₈)alcohol is ethanol, the acid catalyst is an aqueous acidic solution of HCl, and the surfactant of formula (II) is polyethylene (20) oxide hexadecyl ether.
